(19) United States
(12) Patent Application Publication
(10) Pub. No.: US 2024/0000124 A1
(43) Pub. Date: Jan. 4, 2024

(54) DAIRY PRODUCT AND PROCESS

(71) Applicant: Fonterra Co-Operative Group Limited, Auckland (NZ)

(72) Inventors: Biye Chen, Auckland (NL); Aurélie Suzanne Bernadette Leneveu, Auckland (NL); Nicola Jane Robertson, Auckland (NL)

(21) Appl. No.: 18/247,424

(22) PCT Filed: Oct. 15, 2021
(86) PCT No.: PCT/IB2021/059485

§ 371 Date: Mar. 30, 2023

(30) Foreign Application Priority Data
Oct. 16, 2020 (AU) 2020903762

(51) Int. Cl. A23L 33/19; A23L 2/66; A23L 29/269; A23L 2/46

(52) U.S. Cl. CPC A23L 33/19; A23L 2/66; A23L 29/272; A23L 2/46

(57) ABSTRACT

This invention relates to a dairy protein-based beverage with an acceptable shelf life without the use of certain stabilizers. More particularly, this disclosure relates to a beverage, a heat-sterilized beverage and/or a process of making a beverage without the use of certain calcium chelators or polysaccharide thickeners.

### TECHNICAL FIELD

This disclosure relates to a dairy protein-based beverage with good shelf life without the use of certain stabilizers. More particularly, this disclosure relates to a beverage, a heat-sterilized beverage and/or a process of making a beverage without the use of certain stabilizers.

### BACKGROUND ART

Milk proteins are used to provide a high quality source of protein in nutritional beverages. For example, such beverages are used by consumers wishing to maintain/gain or lose weight or muscle.

The shelf life of a product is commercially important. It is difficult for pre-packaged beverage to be sold commercially if it does not have a good shelf life. A good shelf life allows for the product to be produced, shipped around the country or to other countries, to be stocked by the retailer and sold while still having time for the consumer to consume the product before it develops unappealing characteristics, such as sediment, creaming, phase separation or mal odour, or becomes unsafe to consume.

Consumers prefer products with less or no “artificial” ingredients, often referred to as E numbers. However, such ingredients are often required to produce a beverage with a good shelf life and/or viscosity.

For example, US2019/0000129 describes a heat-sterilized composition of 1 to 20% protein with at least one of a saccharide component, a phosphate component and/or a citrate component, to lower the viscosity and/or improve stability without imparting a bitter taste.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of this disclosure to provide a beverage and/or a method of producing a beverage which goes at least some way towards overcoming one or more of the abovementioned problems or difficulties, or to at least provide the industry/public with a useful choice.

### SUMMARY

In a first aspect there is provided a beverage comprising:
about 4-15% w/w casein with a calcium to casein ratio of about 1.8-3.2 g calcium to 100 g casein,
about 0-15% w/w fat,
about 0-30% w/w carbohydrate,
wherein the beverage does not substantially contain or does not contain a stabilizing amount of stabilizers: (i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In some embodiments the beverage is a sterilized beverage.

In a second aspect there is provided a heat-sterilized beverage comprising:
about 4-15% w/w casein with a calcium to casein ratio of about 1.8-3.2 g calcium to 100 g casein,
about 0-15% w/w fat,
about 0-30% w/w carbohydrate,
wherein the beverage does not substantially contain or does not contain a stabilizing amount of stabilizers:(i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In some embodiments the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk.

In a third aspect there is provided a beverage comprising:
about 4-15% w/w casein with a calcium to casein ratio of about 1.8-3.2 g calcium to 100 g casein,
about 0-15% w/w fat,
about 0-30% w/w carbohydrate,
   wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk,
   wherein the beverage does not substantially contain or does not contain a stabilizing amount of the stabilizers:
(i) polysaccharide thickener, wherein the polysaccharide thickener is as defined in any one of A-F below, and
(ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In a fourth aspect there is provided a heat-sterilized beverage comprising:
about 4-15% w/w casein with a calcium to casein ratio of about 1.8-3.2 g calcium to 100 g casein,
about 0-15% w/w fat,
about 0-30% w/w carbohydrate,
   wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk,
wherein the beverage does not substantially contain or does not contain a stabilizing amount of the stabilizers:
   (i) polysaccharide thickener, wherein the polysaccharide thickener is as defined in any one of A-F below, and
   (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In a fifth aspect there is provided a beverage comprising:
about 7.5-15% w/w casein with a calcium to casein ratio of about 1.8-3.2 g calcium to 100 g casein,
about 0-15% w/w fat,
about 0-30% w/w carbohydrate,
about 0-5% w/w polysaccharide thickener,
   wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk,
   wherein the beverage does not substantially contain or does not contain a stabilizing amount of a calcium chelator, wherein the calcium chelator is as defined in I-VII below:
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In a sixth aspect there is provided a heat-sterilized beverage comprising:
about 7.5-15% w/w casein with a calcium to casein ratio of about 1.8-3.2 g calcium to 100 g casein,
about 0-15% w/w fat,
about 0-30% w/w carbohydrate,
about 0-5% w/w polysaccharide thickener,
   wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
calcium depleted skim milk,
skim milk,
calcium depleted whole milk,
whole milk,
wherein the beverage does not substantially contain or does not contain a stabilizing amount of a calcium chelator, wherein the calcium chelator is as defined in I-VII below:
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In an embodiment of the fifth or sixth aspect, the beverage comprises about 0-3% w/w polysaccharide thickener. In an embodiment of the fifth or sixth aspect, the beverage comprises about 0-2% w/w polysaccharide thickener. In an embodiment of the fifth or sixth aspect, the beverage comprises about 0-1% w/w polysaccharide thickener. In an embodiment of the fifth or sixth aspect, the beverage comprises about 0.01-1% w/w polysaccharide thickener. In an embodiment of the fifth or sixth aspect, the beverage comprises about 0.05-0.5% w/w polysaccharide thickener.

In an embodiment of the fifth or sixth aspect, the polysaccharide thickener is selected from one or more food safe polysaccharide thickeners.

In an embodiment of the fifth or sixth aspect, the polysaccharide thickener is selected from any one or more of E number range E1400-E1500 and/or in the range E400-E441, E460-E469.

In an embodiment of the fifth or sixth aspect, the polysaccharide thickener is selected from any one or more of E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),

and/or E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum),

E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose).

In an embodiment of the fifth or sixth aspect, the polysaccharide thickener is selected from any one or more of a starch, gellan, carrageenan, xanthan, carboxymethyl cellulose (CMC), microcrystalline cellulose (MCC), guar, pectin, alginate, agar, locust bean gum, gum Arabic, tragacanth, karaya gum.

In an embodiment of the fifth or sixth aspect, the polysaccharide thickener is selected from any one or more of gellan, carboxymethyl cellulose (CMC), microcrystalline cellulose (MCC), and carrageenan.

For the avoidance of doubt the following embodiments may apply alone or in any combination of two or more thereof to any one or more of the first, second, third, fourth, fifth and/or sixth aspects set forth above where the context allows.

In some embodiments, the calcium to casein ratio is about 1.8-3.1 g of calcium per 100 g of casein. In some embodiments, the calcium to casein ratio is about 1.9-3.1 g of calcium per 100 g of casein. In some embodiments, the calcium to casein ratio is about 1.9-3.0 g of calcium per 100 g of casein. In some embodiments, the calcium to casein ratio is about 1.9-2.9 g of calcium per 100 g of casein. In some embodiments, the calcium to casein ratio is about 1.9-2.8 g of calcium per 100 g of casein. In some embodiments, the calcium to casein ratio is about 2.0-2.7 g of calcium per 100 g of casein. In some embodiments, the calcium to casein ratio is about 2.0-2.6 g of calcium per 100 g of casein.

In some embodiments of the first, second, third or fourth aspects the beverage comprises about 5-15% w/w casein. In some embodiments of the first, second, third or fourth aspects the beverage comprises about 6-15% w/w casein. In some embodiments of the first, second, third or fourth aspects the beverage comprises about 6-13% w/w casein. In some embodiments of the first, second, third or fourth aspects the beverage comprises about 6-12% w/w casein.

In some embodiments of the fifth or sixth aspects the beverage comprises about 8-15% w/w casein. In some embodiments of the fifth or sixth aspects the beverage comprises about 8-13% w/w casein. In some embodiments of the fifth or sixth aspects the beverage comprises about 8-12% w/w casein.

In some embodiments the casein is provided by a combination of a non-calcium depleted dairy ingredient with a calcium depleted dairy ingredient.

In some embodiments the casein is provided by any one of:
i) milk protein concentrate with about 5-45% w/w calcium depletion, or
ii) micellar casein (MC) with about 5-45% w/w calcium depletion, or
iii) calcium depleted milk protein concentrate (MPC) with about 10-95% w/w calcium depletion and/or calcium depleted micellar casein with about 10-95% w/w calcium depletion combined with milk protein concentrate (MPC) and/or micellar casein (MC), or
v) skim milk powder (SMP) and/or whole milk powder (WMP) combined with calcium depleted MPC and/or calcium depleted micellar casein.

In some embodiments the casein is at least in part provided by a calcium depleted dairy ingredient wherein the dairy ingredient has greater than about 1-100% w/w calcium depletion. In some embodiments the casein is at least in part provided by a calcium depleted dairy ingredient wherein the dairy ingredient has about 10-100% w/w calcium depletion. In some embodiments the dairy ingredient has about 10-95% w/w calcium depletion. In some embodiments the casein is at least in part provided by a calcium depleted dairy ingredient wherein the dairy ingredient has about 5-45% w/w calcium depletion. In some embodiments the casein is at least in part provided by a calcium depleted dairy ingredient wherein the dairy ingredient has about 10-40% w/w calcium depletion.

In some embodiments the casein is provided at least in part by calcium depleted milk protein concentrate (MPC) or a mixture of calcium depleted milk protein concentrate (MPC) and non-calcium depleted milk protein concentrate (MPC).

In some embodiments the casein is only provided by calcium depleted milk protein concentrate (MPC) or a mixture of calcium depleted milk protein concentrate (MPC) and non-calcium depleted milk protein concentrate (MPC).

In some embodiments the casein is only provided by calcium depleted milk protein concentrate (MPC) or a mixture of calcium depleted milk protein concentrate (MPC) and non-calcium depleted milk protein concentrate (MPC), wherein the mixture has an overall calcium depletion of 5-45% w/w.

In some embodiments the calcium depleted milk protein concentrate (MPC) has greater than about 1 to 100% w/w calcium depletion. In some embodiments the calcium depleted milk protein concentrate (MPC) has about 10-100% w/w calcium depletion. In some embodiments the calcium depleted milk protein concentrate (MPC) has about 10-95% w/w calcium depletion.

In some embodiments the casein is only provided by a calcium depleted milk protein concentrate MPC.

In some embodiments, the MPC has about 5-45% w/w calcium depletion. In some embodiments, the MPC has about 10-40% w/w calcium depletion.

In some embodiments, the MPC is about 70-90% w/w milk protein on a solids-non-fat basis. In some embodiments, the MPC is about 80-90% w/w milk protein on a solids-non-fat basis. In some embodiments, the MPC is about 85-90% w/w milk protein on a solids-non-fat basis.

In some embodiments, where whey is present, the whey protein has been heated to denature at least a portion of the whey protein.

In some embodiments the MPC has been heat treated to denature at least a portion of the whey protein in the MPC.

In some embodiments the MPC has about 50-100% w/w denatured whey protein. In some embodiments, the MPC has about 80-90% w/w denatured whey protein. In some embodiments, the MPC has about 70-100% w/w denatured whey protein. In some embodiments, the MPC has about 80-90% w/w denatured whey protein.

In some embodiments the beverage has a shelf life of at least 3 months. In some embodiments the beverage has a shelf life of at least 4 months. In some embodiments the beverage has a shelf life of at least 5 months. In some embodiments the beverage has a shelf life of at least 6 months. In some embodiments the beverage has a shelf life of at least 1 year.

In some embodiments the beverage produces less than about 2 g/200 mL of sediment when stored at about 25° C. for 3 months. In some embodiments the beverage produces less than about 1.5 g/200 mL of sediment when stored at about 25° C. for 3 months. In some embodiments the beverage produces less than about 1 g/200 mL of sediment when stored at about 25° C. for 3 months.

In some embodiments the beverage produces less than about 2 g/200 mL of sediment when stored at about 25° C. for 6 months. In some embodiments the beverage produces less than about 1.5 g/200 mL of sediment when stored at about 25° C. for 6 months. In some embodiments the beverage produces less than about 1 g/200 mL of sediment when stored at about 25° C. for 6 months. In some embodiments the beverage produces less than about 0.5 g/200 mL of sediment when stored at about 25° C. for 6 months.

In some embodiments the beverage changes in viscosity by equal to or less than 10 cP measured at a temperature of 20° C. and shear rate of 100 s⁻¹ when stored at about 25° C. for 3 months. In some embodiments the beverage changes in viscosity by equal to or less than 8 cP measured at a temperature of 20° C. and shear rate of 100 s⁻¹ when stored at about 25° C. for 3 months. In some embodiments the beverage changes in viscosity by equal to or less than 5 cP measured at a temperature of 20° C. and shear rate of 100 s⁻¹ when stored at about 25° C. for 3 months. In some embodiments the beverage changes in viscosity by equal to or less than 3 cP measured at a temperature of 20° C. and shear rate of 100 s⁻¹ when stored at about 25° C. for 3 months. In some embodiments the beverage changes in viscosity by equal to or less than 2 cP measured at a temperature of 20° C. and shear rate of 100 s⁻¹ when stored at about 25° C. for 3 months. In some embodiments the beverage changes in viscosity by equal to or less than 1.5 cP measured at a temperature of 20° C. and shear rate of 100 s⁻¹ when stored at about 25° C. for 3 months.

In some embodiments the beverage increases in viscosity by equal to or less than 10 cP measured at a temperature of 20° C. and shear rate of 100 s⁻¹ when stored at about 25° C. for 3 months. In some embodiments the beverage increases in viscosity by equal to or less than 8 cP measured at a temperature of 20° C. and shear rate of 100 s⁻¹ when stored at about 25° C. for 3 months. In some embodiments the beverage increases in viscosity by equal to or less than 5 cP measured at a temperature of 20° C. and shear rate of 100 s⁻¹ when stored at about 25° C. for 3 months. In some embodiments the beverage increases in viscosity by equal to or less than 3 cP measured at a temperature of 20° C. and shear rate of 100 s⁻¹ when stored at about 25° C. for 3 months. In some embodiments the beverage increases in viscosity by equal to or less than 2 cP measured at a temperature of 20° C. and shear rate of 100 s⁻¹ when stored at about 25° C. for 3 months. In some embodiments the beverage increases in viscosity by equal to or less than 1.5 cP measured at a temperature of 20° C. and shear rate of 100 s⁻¹ when stored at about 25° C. for 3 months.

In some embodiments the beverage is stored in capped plastic, glass, or plasticized cardboard containers. In some embodiments the beverage is stored in capped polyethylene terephthalate (PET) containers. In some embodiments the beverage is stored in capped 200 mL plastic containers. In some embodiments the beverage is stored in capped PET 200 mL containers.

In some embodiments, the beverage comprises about 4.5-19% w/w milk protein. In some embodiments, the beverage comprises about 5-19% w/w milk protein. In some embodiments, the beverage comprises about 5-17% w/w milk protein. In some embodiments, the beverage comprises about 5-15% w/w milk protein. In some embodiments, the beverage comprises about 7-15% w/w milk protein. In some embodiments, the beverage comprises about 8-15% w/w milk protein. In some embodiments, the beverage comprises about 10-15% w/w milk protein.

In some embodiments the beverage further comprises any one or more of: whey protein, vegetable protein, collagen.

In some embodiments the beverage comprises about 0-2% w/w whey protein. In some embodiments the beverage comprises about 0.01-2% w/w whey protein. In some embodiments the beverage comprises about 0.05-2% w/w whey protein. In some embodiments the beverage comprises about 0.1-2% w/w whey protein. In some embodiments the beverage comprises about 0.5-2% w/w whey protein. In some embodiments the beverage comprises about 1-2% w/w whey protein.

In some embodiments, the beverage comprises about 0-20% w/w carbohydrate. In some embodiments the beverage comprises about 0-10% w/w carbohydrate. In some embodiments the beverage comprises about 0-5% w/w carbohydrate. In some embodiments the beverage comprises about 0-2% w/w carbohydrate. In some embodiments the beverage comprises about 10-30% w/w carbohydrate.

In some embodiments the carbohydrate is sucrose and/or maltodextrin. In some embodiments the carbohydrate is sucrose and maltodextrin.

In some embodiments, the beverage comprises about 0-14% w/w fat. In some embodiments, the beverage comprises about 0-13% w/w fat. In some embodiments, the beverage comprises about 0-10% w/w fat. In some embodiments, the beverage comprises about 0-5% w/w fat. In some embodiments, the beverage comprises about 0-2% w/w fat. In some embodiments, the beverage comprises about 0-1.5% w/w fat. Alternatively, in some embodiments, the beverage comprises about 5-15% w/w fat. In some embodiments, the beverage comprises about 5-12% w/w fat. In some embodiments, the beverage comprises about 5-10% w/w fat. In some embodiments, the beverage comprises about 5-8% w/w fat.

In some embodiments the fat is oil. In some embodiments the oil is vegetable oil or a dairy fat. In some embodiments the fat is anhydrous milk fat (AM F).

In some embodiments the beverage has total solids of about 4 to 60% w/w. In some embodiments the beverage has total solids of about 5 to 50% w/w. In some embodiments the beverage has total solids of about 5 to 40% w/w. In some embodiments the beverage has total solids of about 5 to 30% w/w. In some embodiments the beverage has total solids of about 10 to 30% w/w.

In some embodiments the beverage comprises one or more additional mineral(s) and/or vitamin(s).

In some embodiments the additional minerals and/or vitamins is selected from a magnesium source, a calcium source.

In some embodiments the beverage comprises one or more of: di magnesium phosphate, calcium carbonate, potassium chloride, calcium phosphate, magnesium hydroxide, magnesium chloride, sodium chloride, calcium hydroxide, magnesium oxide.

In some embodiments about 7-100% of the energy provides by the beverage is provided by protein. In some embodiments about 10-30% of the energy provided by the beverage is provided by protein. In some embodiments about 60-100% of the energy provided by the beverage is provided by protein.

In some embodiments the beverage comprises about 0-5% w/w lactose and/or products of lactose hydrolysis. In some embodiments the beverage comprises about 0-4% w/w lactose and/or products of lactose hydrolysis. In some embodiments the beverage comprises about 0-3% w/w lactose and/or products of lactose hydrolysis. In some embodiments the beverage comprises about 0-2% w/w lactose and/or products of lactose hydrolysis. In some embodiments the beverage comprises about 0-1% w/w lactose and/or products of lactose hydrolysis.

In some embodiments the products of lactose hydrolysis are glucose and/or galactose.

In some embodiments the pH of the beverage is about 6.5-7.4. In some embodiments the pH of the beverage is about 6.6-7.2. In some embodiments the pH of the beverage is about 6.6-7.0. In some embodiments the pH of the beverage is about 6.7-6.9.

In some embodiments the beverage comprises an acidity regulator. In some embodiments the acidity regulator is an acid and/or a base. In some embodiments the acidity regulator is selected from any one or more of: sodium hydroxide, potassium hydroxide, lactic acid, acetic acid, malic acid, fumaric acid, tartaric acid.

In some embodiments the beverage has been sterilized. In some embodiment the beverage is a sterilized beverage.

In some embodiments the beverage has received a sterilizing heat treatment.

In some embodiments the sterilizing heat treatment is UHT or retort.

In some embodiments the sterilizing heat treatment is high temperature sterilizing. In some embodiments the high temperature is about 90° C. to about 150° C. for about 0.25 second to about 60 minutes.

In some embodiments the high temperature sterilization comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, seconds or at least about 1, 2, 3, 4, 5, 6, 7, 8, 9, 10 or at least about 60 minutes.

In some embodiments the high temperature sterilizing comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 s to about 10 minutes, about 0.1 s to about 1 minute, about 0.1 s to about 30 s, about 0.5 s to about 30 s, about 1 s to about 30 s, about 3 s to about 30 s about 0.1 s to about 20 s, about 0.5 to about 20 s, about 1 to about 20 s, about 3 to about 20 s, about 0.1 to about 10 s, about 1 to about 10 s, about 3 to about 10 s, about 0.1 to about 7 s, about 1 to about 7 s, about 3 to about 7 s, about 0.1 to about 5 s, about 1 to about 5 s or about 3 s to about 5 s.

In some embodiments the high temperature sterilizing comprises heat treating the beverage at a temperature of at least about 115° C. for at least about 2 s, at least about 120° C. for at least about 2 s, at least about 125° C. for at least about 2 s, at least about 130° C. for at least about 1 s, at least about 135° C. for at least about 1 s, at least about 138° C. for at least about 1 s, at least about 130° C. for at least about 3 s, at least about 135° C. for at least about 3 s, at least about 138° C. for at least about 3 s, from about 130 to about 150° C. for at least about 1 s, from about 130 to about 150° C. for at least about 3 s, from about 135 to about 150° C. for at least about 1 s, from about 135 to about 150° C. for at least about 3 s, from about 138 to about 145° C. for at least about 1 s, from about 138 to about 145° C. for at least about 3 s, at least about 130° C. for about 1 s to about 10 s, at least about 135° 5 C for about 1 s to about 10 s, at least about 138° C. for about 1 s to about 10 s, from about 135 to about 150° C. for about 1 s to about 10 s, from about 138 to about 145 ° C. for about 1 s to about 10 s, from about 135 to about 150° C. for about 3 s to about 5 s, or from about 138 to about 145° C. for about 3 s to about 5 s.

In some embodiments sterilization gives an Fo value of at least about 5, or at least about 3. In some embodiments the heat treatment has an Fo value of at least equivalent to 90° C. for 40 s, 121.1° C. for 3 min, 130° C. for 25 s, 140° C. for 2.5 s or 150° C. for 0.25 s.

In in a seventh aspect there is provided a process of making a beverage, the process comprising:
heating at a sterilization temperature an aqueous mixture comprising
   about 4-15% w/w casein with a calcium to casein ratio of about 1.8-3.2 g calcium to 100 g casein,
   about 0-15% w/w fat,
   about 0-30% w/w carbohydrate,
wherein the beverage does not substantially contain or does not contain a stabilizing amount of stabilizers:(i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417

(Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In some embodiments the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP)
whole milk powder (WMP),
skim milk,
calcium depleted skim milk,
whole milk,
calcium depleted whole milk.

In in an eighth aspect there is provided a process of making a beverage, the process comprising:
heating at a sterilization temperature an aqueous mixture comprising
about 4-15% w/w casein with a calcium to casein ratio of about 1.8-3.2 g calcium to 100 g casein,
about 0-15% w/w fat,
about 0-30% w/w carbohydrate,
   wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk,
wherein the beverage does not substantially contain or does not contain a stabilizing amount of stabilizers:(i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In in a ninth aspect there is provided a process of making a beverage, the process comprising:
heating at a sterilization temperature an aqueous mixture comprising
   about 7.5-15% w/w casein with a calcium to casein ratio of about 1.8-3.2 g calcium to 100 g casein,
   about 0-15% w/w fat,
   about 0-30% w/w carbohydrate,
   about 0-5% w/w polysaccharide thickener,
      wherein the casein is provided by any one or more of the following dairy ingredients:
calcium depleted milk protein concentrate (MPC),
non-calcium depleted milk protein concentrate (MPC),
calcium depleted milk protein isolate (MPI),
non-calcium depleted milk protein isolate (MPI),
calcium depleted liquid milk protein concentrate,
non calcium depleted liquid milk protein concentrate,
calcium depleted liquid micellar casein,
non-calcium depleted liquid micellar casein,
calcium depleted ultrafiltration (UF) and/or microfiltration (MF) retentate of milk,
non-calcium depleted ultrafiltration (UF) and/or microfiltration (MF) retentate of milk,
calcium depleted micellar casein,
non-calcium depleted micellar casein,
calcium depleted skim milk powder (SMP),
skim milk powder (SMP),
calcium depleted whole milk powder (WMP),
whole milk powder (WMP),
calcium depleted skim milk,
skim milk,
calcium depleted whole milk,
whole milk,
   wherein the beverage does not substantially contain or does not contain a stabilizing amount of a calcium chelator, wherein the calcium chelator is as defined in I-VII below:
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In an embodiment of the ninth aspect, the aqueous mixture comprises about 0-3% w/w polysaccharide thickener. In an embodiment of the ninth aspect, the aqueous mixture comprises about 0-2% w/w polysaccharide thickener. In an embodiment of the ninth aspect, the aqueous mixture comprises about 0-1% w/w polysaccharide thickener. In an embodiment of the ninth aspect, the aqueous mixture comprises about 0.01-1% w/w polysaccharide thickener. In an embodiment of the ninth aspect, the aqueous mixture comprises about 0.05-0.5% w/w polysaccharide thickener.

In an embodiment of the ninth aspect, the polysaccharide thickener is selected from one or more food safe polysaccharide thickeners.

In an embodiment of the ninth aspect, the polysaccharide thickener is selected from any one or more of E number range E1400-E1500 and/or in the range E400-E441, E460-E469.

In an embodiment of the ninth aspect, the polysaccharide thickener is selected from any one or more of E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),

and/or E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose).

In an embodiment of the ninth aspect, the polysaccharide thickener is selected from any one or more of a starch, gellan, carrageenan, xanthan, carboxymethyl cellulose (CMC), microcrystalline cellulose (MCC), guar, pectin, alginate, agar, locust bean gum, gum Arabic, tragacanth, karaya gum.

In an embodiment of the ninth aspect, the polysaccharide thickener is selected from any one or more of gellan, carboxymethyl cellulose (CMC), microcrystalline cellulose (MCC), and carrageenan.

For the avoidance of doubt the following embodiments may apply alone or in any combination of two or more thereof to any one or more of the first, second, third, fourth, fifth, sixth, seventh, eighth and/or ninth aspects set forth above where the context allows.

In some embodiments, the calcium to casein ratio is about 1.8 -3.2 g of calcium per 100 g of casein. In some embodiments, the calcium to casein ratio is about 1.8-3.1 g of calcium per 100 g of casein. In some embodiments, the calcium to casein ratio is about 1.9-3.1 g of calcium per 100 g of casein. In some embodiments, the calcium to casein ratio is about 1.9-3.0 g of calcium per 100 g of casein. In some embodiments, the calcium to casein ratio is about 1.9-2.9 g of calcium per 100 g of casein. In some embodiments, the calcium to casein ratio is about 1.9-2.8 g of calcium per 100 g of casein. In some embodiments, the calcium to casein ratio is about 2.0-2.7 g of calcium per 100 g of casein. In some embodiments, the calcium to casein ratio is about 2.0-2.6 g of calcium per 100 g of casein.

In some embodiments the casein is provided by a combination of a non-calcium depleted dairy ingredient with a calcium depleted dairy ingredient.

In some embodiments the casein is provided by any one of:
i) milk protein concentrate with about 5-45% calcium depletion, or
ii) micellar casein (MC) with about 5-45% calcium depletion, or
iii) calcium depleted milk protein concentrate (MPC) with about 10-95% w/w calcium depletion and/or calcium depleted micellar casein with about 10-95% w/w calcium depletion combined with milk protein concentrate (MPC) and/or micellar casein (MC), or
iv) skim milk powder (SMP) and/or whole milk powder (WMP) combined with calcium depleted MPC and/or calcium depleted micellar casein.

In some embodiments of seventh or eighth aspects the aqueous mixture comprises about 5-15% w/w casein. In some embodiments of the seventh or eighth aspects the aqueous mixture comprises about 6-15% w/w casein. In some embodiments of the seventh or eighth aspects the aqueous mixture comprises about 6-13% w/w casein. In some embodiments of the seventh or eighth aspects the aqueous mixture comprises about 6-12% w/w casein.

In some embodiments of the ninth aspect the aqueous mixture comprises about 8-15% w/w casein. In some embodiments of the ninth aspect the aqueous mixture comprises about 8-13% w/w casein. In some embodiments of the ninth aspect the aqueous mixture comprises about 8-12% w/w casein.

In some embodiments the casein is at least in part provided by a calcium depleted dairy ingredient wherein the dairy ingredient has greater than about 1 to 100% w/w calcium depletion. In some embodiments the casein is at least in part provided by a calcium depleted dairy ingredient wherein the dairy ingredient has about 10 to 100% w/w calcium depletion. In some embodiments the casein is at least in part provided by a calcium depleted dairy ingredient wherein the dairy ingredient has about 10 to 95% w/w calcium depletion. In some embodiments the casein is at least in part provided by a calcium depleted dairy ingredient wherein the dairy ingredient has about 5-45% w/w calcium depletion. In some embodiments the casein is at least in part provided by a calcium depleted dairy ingredient wherein the dairy ingredient has about 10-40% w/w calcium depletion.

In some embodiments the calcium depleted dairy ingredient is prepared by cation exchange.

In some embodiments the calcium depleted dairy ingredient is prepared by cation exchange on an ion exchanger charged with a one or more species of monovalent cation. In some embodiments the one or more species of monovalent cation are one or more of sodium and potassium. In some embodiments the ion exchanger is a resin.

In some embodiments the casein is provided by at least in part calcium depleted milk protein concentrate (MPC) or a mixture of calcium depleted milk protein concentrate (MPC) and non-calcium depleted milk protein concentrate (MPC).

In some embodiments the casein is only provided by calcium depleted milk protein concentrate (MPC) or a mixture of calcium depleted milk protein concentrate (MPC) and non-calcium depleted milk protein concentrate (MPC).

In some embodiments the casein is only provided by calcium depleted milk protein concentrate (MPC) or a mixture of calcium depleted milk protein concentrate (MPC) and non-calcium depleted milk protein concentrate (MPC), wherein the mixture has an overall calcium depletion of 5-45%.

In some embodiments the calcium depleted milk protein concentrate (MPC) has greater than about 1 to 100% calcium depletion. In some embodiments the calcium depleted milk protein concentrate (MPC) has about 10 to 100% calcium depletion. In some embodiments the calcium depleted milk protein concentrate (MPC) has about 10 to 95% calcium depletion.

In some the calcium depleted milk protein concentrate (MPC) is prepared by cation exchange.

In some embodiments the calcium depleted dairy ingredient is prepared by cation exchange on an ion exchanger charged substantially with a single species of monovalent cation.

In some embodiments the casein is only provided by a calcium depleted milk protein concentrate MPC.

In some embodiments, the MPC has about 5-45% w/w calcium depletion. In some embodiments, the MPC has about 10-40% w/w calcium depletion.

In some embodiments, the MPC is about 70-90% w/w milk protein on a solids-non-fat basis. In some embodiments, the MPC is about 80-90% w/w milk protein on a solids-non-fat basis. In some embodiments, the MPC is about 85-90% w/w milk protein on a solids-non-fat basis.

In some embodiments, where whey is present, the whey protein has been heated to denature at least a portion of the whey protein prior to addition to the aqueous mixture.

In some embodiments the MPC has been heat treated to denature at least a portion of the whey protein in the MPC prior to addition to the aqueous mixture.

In some embodiments the MPC has about 50-100% denatured whey protein. In some embodiments, the MPC has about 80-90% denatured whey protein. In some embodiments, the MPC has about 70-100% denatured whey protein. In some embodiments, the MPC has about 80-90% denatured whey protein.

In some embodiments the beverage has a shelf life of at least 3 months. In some embodiments the beverage has a shelf life of at least 4 months. In some embodiments the beverage has a shelf life of at least 5 months. In some embodiments the beverage has a shelf life of at least 6 months. In some embodiments the beverage has a shelf life of at least 1 year.

In some embodiments the beverage produces less than about 2 g/200 mL of sediment when stored at about 25° C. for 3 months. In some embodiments the beverage produces less than about 1.5 g/200 mL of sediment when stored at about 25° C. for 3 months. In some embodiments the beverage produces less than about 1 g/200 mL of sediment when stored at about 25° C. for 3 months.

In some embodiments the beverage produces less than about 2 g/200 mL of sediment when stored at about 25° C. for 6 months. In some embodiments the beverage produces less than about 1.5 g/200 mL of sediment when stored at about 25° C. for 6 months. In some embodiments the beverage produces less than about 1 g/200 mL of sediment when stored at about 25° C. for 6 months. In some embodiments the beverage produces less than about 0.5 g/200 mL of sediment when stored at about 25° C. for 6 months.

In some embodiments the beverage changes in viscosity by equal to or less than 10 cP measured at a temperature of 20° C. and shear rate of 100 s⁻¹ when stored at about 25° C. for 3 months. In some embodiments the beverage changes in viscosity by equal to or less than 8 cP measured at a temperature of 20° C. and shear rate of 100 s⁻¹ when stored at about 25° C. for 3 months. In some embodiments the beverage changes in viscosity by equal to or less than 5 cP measured at a temperature of 20° C. and shear rate of 100 s⁻¹ when stored at about 25° C. for 3 months. In some embodiments the beverage changes in viscosity by equal to or less than 3 cP measured at a temperature of 20° C. and shear rate of 100 s⁻¹ when stored at about 25° C. for 3 months. In some embodiments the beverage changes in viscosity by equal to or less than 2 cP measured at a temperature of 20° C. and shear rate of 100 s⁻¹ when stored at about 25° C. for 3 months. In some embodiments the beverage changes in viscosity by equal to or less than 1.5 cP measured at a temperature of 20° C. and shear rate of 100 s⁻¹ when stored at about 25° C. for 3 months.

In some embodiments the beverage increases in viscosity by equal to or less than 10 cP measured at a temperature of 20° C. and shear rate of 100 s⁻¹ when stored at about 25° C. for 3 months. In some embodiments the beverage increases in viscosity by equal to or less than 8 cP measured at a temperature of 20° C. and shear rate of 100 s⁻¹ when stored at about 25° C. for 3 months. In some embodiments the beverage increases in viscosity by equal to or less than 5 cP measured at a temperature of 20° C. and shear rate of 100 s⁻¹ when stored at about 25° C. for 3 months. In some embodiments the beverage increases in viscosity by equal to or less than 3 cP measured at a temperature of 20° C. and shear rate of 100 s⁻¹ when stored at about 25° C. for 3 months. In some embodiments the beverage increases in viscosity by equal to or less than 2 cP measured at a temperature of 20° C. and shear rate of 100 s⁻¹ when stored at about 25° C. for 3 months. In some embodiments the beverage increases in viscosity by equal to or less than 1.5 cP measured at a temperature of 20° C. and shear rate of 100 s⁻¹ when stored at about 25° C. for 3 months.

In some embodiments the beverage is stored in capped plastic, glass, or plasticized cardboard (for example Tetra Pak Tetra Brik) containers. In some embodiments the beverage is stored in capped polyethylene terephthalate (PET) containers. In some embodiments the beverage is stored in capped 200 mL plastic containers. In some embodiments the beverage is stored in capped PET 200mL containers.

In some embodiments, the beverage comprises about 4.5-19% w/w milk protein. In some embodiments, the beverage comprises about 5-19% w/w milk protein. In some embodiments, the beverage comprises about 5-17% w/w milk protein. In some embodiments, the beverage comprises about 5-15% w/w milk protein. In some embodiments, the beverage comprises about 7-15% w/w milk protein. In some embodiments, the beverage comprises about 8-15% w/w milk protein. In some embodiments, the beverage comprises about 10-15% w/w milk protein.

In some embodiments the beverage further comprises any one or more of: whey protein, vegetable protein, collagen.

In some embodiments the beverage comprises about 0-2% w/w whey protein. In some embodiments the beverage comprises about 0.01-2% w/w whey protein. In some embodiments the beverage comprises about 0.05-2% w/w whey protein. In some embodiments the beverage comprises about 0.1-2% w/w whey protein. In some embodiments the beverage comprises about 0.5-2% w/w whey protein. In some embodiments the beverage comprises about 1-2% w/w whey protein.

In some embodiments, the beverage comprises about 0-20% w/w carbohydrate. In some embodiments the beverage comprises about 0-10% w/w carbohydrate. In some embodiments the beverage comprises about 0-5% w/w carbohydrate. In some embodiments the beverage comprises about 0-2% w/w carbohydrate. In some embodiments the beverage comprises about 10-30% w/w carbohydrate.

In some embodiments the carbohydrate is sucrose and/or maltodextrin. In some embodiments the carbohydrate is sucrose and maltodextrin.

In some embodiments, the beverage comprises about 0-14% w/w fat. In some embodiments, the beverage comprises about 0-13% w/w fat. In some embodiments, the beverage comprises about 0-12% w/w fat. In some embodiments, the beverage comprises about 0-10% w/w fat. In some embodiments, the beverage comprises about 0-5% w/w fat. In some embodiments, the beverage comprises about 0-2% w/w fat. In some embodiments, the beverage comprises about 0-1.5% w/w fat. Alternatively, in some embodiments, the beverage comprises about 5-15% w/w fat. In some embodiments, the beverage comprises about 5-12% w/w fat. In some embodiments, the beverage comprises about 5-10% w/w fat. In some embodiments, the beverage comprises about 5-8% w/w fat.

In some embodiments the fat is oil. In some embodiments the oil is vegetable oil or a dairy fat. In some embodiments the fat is anhydrous milk fat (AMF).

In some embodiments the beverage has total solids of about 4 to 60% w/w. In some embodiments the beverage has total solids of about 5 to 50% w/w. In some embodiments the beverage has total solids of about 5 to 40% w/w. In some embodiments the beverage has total solids of about 5 to 30% w/w. In some embodiments the beverage has total solids of about 10 to 30% w/w.

In some embodiments the aqueous mixture comprises one or more additional minerals and/or vitamins.

In some embodiments the additional minerals and/or vitamins is selected from a magnesium source, a calcium source.

In some embodiments the aqueous mixture comprises one or more of: di magnesium phosphate, calcium carbonate, potassium chloride, calcium phosphate, magnesium hydroxide, magnesium chloride, sodium chloride, calcium hydroxide, magnesium oxide.

In some embodiments 7-100% of the energy provided by the beverage is provided by protein. In some embodiments 10-30% of the energy provided by the beverage is provided by protein. In some embodiments 60-100% of the energy provided by the beverage is provided by protein.

In some embodiments the beverage comprises about 0-5% w/w lactose and/or products of lactose hydrolysis. In some embodiments the beverage comprises about 0-4% w/w lactose and/or products of lactose hydrolysis. In some embodiments the beverage comprises about 0-3% w/w lactose and/or products of lactose hydrolysis. In some embodiments the beverage comprises about 0-2% w/w lactose and/or products of lactose hydrolysis. In some embodiments the beverage comprises about 0-1% w/w lactose and/or products of lactose hydrolysis.

In some embodiments the products of lactose hydrolysis are glucose and/or galactose.

In some embodiments the pH of the beverage is or is adjusted to be about 6.5-7.4. In some embodiments the pH of the beverage is or is adjusted to be about 6.6-7.2. In some embodiments the pH of the beverage is about 6.6-7.0. In some embodiments the pH of the beverage is about 6.7-6.9.

In some embodiments the pH is adjusted with the addition an acidity regulator.

In some embodiments the acidity regulator is an acid and/or a base.

In some embodiments the acidity regulator is selected from any one or more of: sodium hydroxide, potassium hydroxide, lactic acid, acetic acid, malic acid, fumaric acid, tartaric acid.

In some embodiments the heating at a sterilizing temperature is UHT or retort treatment.

In some embodiments the sterilization temperature is high temperature.

In some embodiments the sterilization temperature is about 90° C. to about 150° C. for about 0.25 second to about 60 minutes.

In some embodiments the heating at a sterilization temperature comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, 60 seconds or at least about 1, 2, 3, 4, 5, 6, 7, 8, 9, 10 or at least about 60 minutes.

In some embodiments the heating at a sterilization temperature comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 s to about 10 minutes, about 0.1 s to about 1 minute, about 0.1 s to about 30 s, about 0.5 s to about 30 s, about 1 s to about 30 s, about 3 s to about 30 s about 0.1 s to about 20 s, about 0.5 to about 20 s, about 1 to about 20 s, about 3 to about 20 s, about 0.1 to about 10 s, about 1 to about 10 s, about 3 to about 10 s, about 0.1 to about 7 s, about 1 to about 7 s, about 3 to about 7 s, about 0.1 to about 5 s, about 1 to about 5 s or about 3 s to about 5 s.

In some embodiments the heating at a sterilization temperature comprises heat treating the beverage at a temperature of at least about 115° C. for at least about 2 s, at least about 120° C. for at least about 2 s, at least about 125° C. for at least about 2 s, at least about 130° C. for at least about 1 s, at least about 135° C. for at least about 1 s, at least about 138° C. for at least about 1 s, at least about 130° C. for at least about 3 s, at least about 135° C. for at least about 3 s, at least about 138° C. for at least about 3 s, from about 130 to about 150° C. for at least about 1 s, from about 130 to about 150° C. for at least about 3 s, from about 135 to about 150° C. for at least about 1 s, from about 135 to about 150° C. for at least about 3 s, from about 138 to about 145° C. for at least about 1 s, from about 138 to about 145° C. for at least about 3 s, at least about 130° C. for about 1 s to about 10 s, at least about 135° 5 C. for about 1 s to about 10 s, at least about 138° C. for about 1 s to about 10 s, from about 135 to about 150° C. for about 1 s to about 10 s, from about 138 to about 145° C. for about 1 s to about 10 s, from about 135 to about 150° C. for about 3 s to about 5 s, or from about 138 to about 145° C. for about 3 s to about 5 s.

In some embodiments heating at a sterilization temperature gives an Fo value of at least about 5, or at least about 3. In some embodiments the heating at a sterilization temperature has an Fo value of at least equivalent to 90° C. for 40 s, 121.1° C. for 3 min, 130° C. for 25 s, 140° C. for 2.5 s or 150° C. for 0.25 s.

In some embodiments the aqueous mixture is warmed to facilitate mixing.

In some embodiments the beverage is homogenised.

In some embodiments the beverage is homogenised at a total homogenising pressure of about 100 to about 1000 bars. In some embodiments the beverage is homogenised at a total homogenising pressure of about 100 to about 600 bars. In some embodiments the beverage is homogenised at a total homogenising pressure of about 100 to about 500 bars. In some embodiments the beverage is homogenised at a total homogenising pressure of about 100 to about 400 bars.

In some embodiments the sterilized beverage is cooled under aseptic conditions.

In some embodiments the sterilized beverage is aseptically packaged.

In some embodiments the beverage is packaged in plastic, glass, or plasticized cardboard containers. In some embodiments the beverage is packaged in polyethylene terephthalate (PET) containers. In some embodiments the beverage is packaged in 200 mL plastic containers. In some embodiments the beverage is packaged in PET 200 mL containers.

Any of the aforementioned features or embodiments or aspects may be combined with one or more of the other features or embodiments or aspects as described herein.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed.

These are only examples of what is specifically intended and all possible combinations of numerical values between the lowest value and the highest value enumerated are to be considered to be expressly stated in this application in a similar manner.

As used herein the term “and/or” means “and” or “or”, or both. As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### BRIEF DESCRIPTION OF THE FIGURES

Preferred embodiments of the disclosure will be described by way of example only and with reference to the following drawings.

FIG. 1 shows a bar graph of the amount of sediment formed after 1 month, 3 months, 6 months, 9 months and 12 months of storage of beverages 1 and 4 compared to other control/comparative beverages 2 and 3.

FIG. 2 shows a bar graph of the amount of sediment formed after 1 month and 3 months of storage of beverages 5, 6 and 7.

FIG. 3 shows a bar graph of the amount of sediment formed after 1 month and 3 months for of storage of beverages 8 and after 1 month, 3 months, 6 months and 12 months of storage for beverage 9 and 10 and 9 (comparative) and 10 (comparative).

FIG. 4 shows a bar graph of the amount of sediments formed after 1, 3, 6, 9 and 12 months for beverage 11, after 1, 3, 6 months for beverage 12, after 1, 3, 6 and 9 months for beverage 13, after 1, 4 and 6 months for beverage 14 (note, beverage 14 sample labelled as 3 months in the graph was done at 4 months), after 1, 3, 6 and 12 months for beverage 16, after 1, 3 and 6 months for beverage 17 and after 1, 3 and 6 months for beverage 18.

FIG. 5 shows a bar graph of the amount of sediment formed after 1 month, 3 months and 6 months of storage of beverage 19.

### DETAILED DESCRIPTION

Described herein is a beverage and/or a heat-sterilized beverage comprising about 4-15% w/w casein with a calcium to casein ratio of about 1.8-3.2 g calcium to 100 g casein, about 0-15% w/w fat, about 0-30% w/w carbohydrate, wherein the beverage does not substantially contain or does not contain a stabilizing amount of stabilizers: (i) polysaccharide thickener, wherein the polysaccharide thickener is as defined herein, and (ii) calcium chelator, wherein the calcium chelator is as defined herein. The beverage may be a sterilized beverage.

Further or alternatively described herein is a beverage comprising: about 4-15% w/w casein with a calcium to casein ratio of about 1.8-3.2 g calcium to 100 g casein, about 0-15% w/w fat, about 0-30% w/w carbohydrate. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of the stabilizers:
(i) polysaccharide thickener, wherein the polysaccharide thickener is as defined in any one of A-F below, and
(ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),
   and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

Further or alternatively described herein is a heat-sterilized beverage comprising: about 4-15% w/w casein with a calcium to casein ratio of about 1.8-3.2 g calcium to 100 g casein, about 0-15% w/w fat, about 0-30% w/w carbohydrate. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of stabilizers (i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate), and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

Further or alternatively described herein is a process of making a beverage and/or a process of stabilising a beverage. The process comprising heating at a sterilization temperature an aqueous mixture comprising about 4-15% w/w casein with a calcium to casein ratio of about 1.8-3.2 g calcium to 100 g casein, about 0-15% w/w fat, about 0-30% w/w carbohydrate, about lactose 0-5% w/w, wherein the aqueous mixture does not substantially contain or does not contain a stabilizing amount of the stabilizers: (i) polysaccharide thickener, wherein the polysaccharide thickener is as defined herein, and (ii) calcium chelator, wherein the calcium chelator is as defined herein.

Described herein is a process of making a beverage and/or a process of stabilising a beverage. The process comprising: heating at a sterilization temperature an aqueous mixture comprising about 4-15% w/w casein with a calcium to casein ratio of about 1.8-3.2 g calcium to 100 g casein, about 0-15% w/w fat, about 0-30% w/w carbohydrate. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of stabilizers:(i) polysaccharide thickener, wherein the polysaccharide thickener is as defined in any one of A-F below, and (ii) calcium chelator, wherein the calcium chelator is as defined in I-VII below:
A. wherein the polysaccharide thickener is any one or more of gellan, carboxymethyl cellulose (CMC), microcrystalline cellulose (MCC), and carrageenan;
B. wherein the polysaccharide thickener consists of the group gellan, carboxymethyl cellulose (CMC), microcrystalline cellulose (MCC), and carrageenan;
C. wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
D. wherein the polysaccharide thickener consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate), and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose);
E. wherein the polysaccharide thickener consists of the thickeners in the E number range E1400-E1500 and/or in the range E400-E441, E460-E469;
F. wherein the polysaccharide thickener consists of the group: food safe polysaccharide thickeners;
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

In particular, described herein is a beverage, sterilized beverage or process of making beverage which provides a stable beverage without the use of a polysaccharide thickener stabilizer or a calcium chelator stabilizer and/or avoiding the use of groups of or specific commonly used stabilizers.

In some instances a polysaccharide thickener may be used in a beverage and/or a process of making a beverage, where it is not specifically excluded.

Further or alternatively described herein is a beverage comprising: about 7.5-15% w/w casein with a calcium to casein ratio of about 1.8-3.2 g calcium to 100 g casein, about 0-15% w/w fat, about 0-30% w/w carbohydrate, about 0-5% w/w polysaccharide thickener. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of a calcium chelator, wherein the calcium chelator is as defined herein in I-VII.

Further or alternatively described herein is a heat-sterilized beverage comprising: about 7.5-15% w/w casein with a calcium to casein ratio of about 1.8-3.2 g calcium to 100 g casein, about 0-15% w/w fat, about 0-30% w/w carbohydrate, about 0-5% w/w polysaccharide thickener. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of a calcium chelator, wherein the calcium chelator is as defined herein in I-VII.

Further or alternatively described herein is a process of making a beverage and/or a process of stabilising a beverage. The process comprising: heating at a sterilization temperature an aqueous mixture comprising about 7.5-15% w/w casein with a calcium to casein ratio of about 1.8-3.2 g calcium to 100 g casein, about 0-15% w/w fat, about 0-30% w/w carbohydrate, about 0-5% w/w polysaccharide thickener. The casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk. The beverage does not substantially contain or does not contain a stabilizing amount of a calcium chelator, wherein the calcium chelator is as defined in I-VII below:
I. wherein the calcium chelator is potassium citrate;
II. wherein the calcium chelator consists of monovalent mineral salts of phosphate and citrate;
III. wherein the calcium chelator consists of monovalent mineral salts of phosphate, citrate, and tartrate;
IV. wherein the calcium chelator stabilizer is the E numbers E339, E340, E365, E450-452, E 391;
V. wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate);
VI. wherein the calcium chelator consists of glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate;
VII. wherein the calcium chelator consists of the group: food safe calcium chelators.

The use of a casein source with a calcium to casein ratio of about 1.8-3.2 g calcium to 100 g casein provides surprising stability to a dairy protein beverage with about w/w fat and about 0-30% w/w carbohydrate. As demonstrated in Example 1, when stored over months dairy based protein beverages, without a stabilizer will usually develop sediment. Sediment will make the product unappealing to the consumer. However, there is also increasing consumer demand for protein beverages which do not have long ingredient lists or contain what are perceived to be artificial stabilizers or other additives. While there is a demand for products with less “artificial” ingredients, having a long self-life is also preferred by the consumer, producer and retailers. It is therefore a significant advantage to be able to produce a stable dairy protein beverage, without the use of a polysaccharide thickener stabilizer or a calcium chelator stabilizer, and/or groups of, or specific commonly used stabilizers.

The calcium to casein ratio in the casein used is preferably about 1.8 -3.2 g of calcium per 100 g of casein, about 1.8-3.1 g of calcium per 100 g of casein, about 1.9-3.1 g of calcium per 100 g of casein, about 1.9-3.0 g of calcium per 100 g of casein, about 1.9-2.9 g of calcium per 100 g of casein, about 1.9-2.8 g of calcium per 100 g of casein, about 2.0-2.7 g of calcium per 100 g of casein or about 2.0-2.6 g of calcium per 100 g of casein.

The ratio of calcium to casein is lower than the standard found in dairy products. The normal/standard ratio of calcium to casein found naturally in dairy products varies between products, however, for comparison commercially available MPC470 has a calcium to casein ratio of about 3.9 g calcium to 100 g casein, commercially available MPC480 has a calcium to casein ratio of about 3.40-3.5 g calcium to 100 g casein, commercially available MPI may have a calcium to casein ratio of about 3.24-3.3 g calcium to 100 g casein, commercially available micellar casein may have a calcium to casein ratio of about 3.3 g calcium to 100 g casein, commercially available SMP may have a calcium to casein ratio of about 4.6 g calcium to 100 g casein.

### Sources of Casein

The casein in the beverage, sterilized beverage or used in the process is preferably from one or dairy ingredients selected from: calcium depleted milk protein concentrate (MPC),non-calcium depleted milk protein concentrate (MPC), calcium depleted milk protein isolate (MPI), non-calcium depleted milk protein isolate (MPI), calcium depleted liquid milk protein concentrate, non calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), skim milk, calcium depleted skim milk, whole milk, calcium depleted whole milk, however, the combined calcium to casein ratio is still as discussed above. For example, if a whole milk is used, it is combined with another casein source which will lower the overall casein to calcium ratio, for example to about 1.8-3.2 g calcium to 100 g casein. For the avoidance of doubt where an ingredient does not specificity it is calcium depleted, it is non-calcium depleted and has its normal level of calcium.

The casein is preferably provided by a combination of one or more of the non-calcium depleted dairy ingredient(s) with one or more of the calcium depleted dairy ingredient(s).

The casein is preferably provided by any one of the following:
i) milk protein concentrate with about 5-45% w/w calcium depletion, or
ii) micellar casein (MC) with about 5-45% w/w calcium depletion, or
iii) calcium depleted milk protein concentrate (MPC) with about 10-95% w/w calcium depletion and/or calcium depleted micellar casein with about 10-95% w/w calcium depletion combined with milk protein concentrate (MPC) and/or micellar casein (MC), or
iv) skim milk powder (SMP) and/or whole milk powder (WMP) combined with calcium depleted MPC and/or calcium depleted micellar casein.

The casein is preferably at least in part provided by a calcium depleted dairy ingredient wherein the dairy ingredient has greater than about 1 to 100% w/w calcium depletion, about 10 to 100% w/w calcium depletion, about 10 to 95% w/w, about 5-45% w/w calcium depletion, about 10-40% w/w calcium depletion.

The calcium depleted dairy ingredient may be prepared by cation exchange, for example prepared by cation exchange on an ion exchanger charged with one or more species of monovalent cation. The monovalent cation may be one or more of sodium and potassium.

The casein is preferably provided by a milk protein concentrate (MPC). MPCs are relatively easy to ship, store or keep until use in the beverage, handle and can be produced consistently. MPCs also allow for the option to have low lactose levels, compared to milk powders, if desired. MPCs are therefore convenient and preferred for use in the beverage, sterilized beverage and process described herein. The casein in the beverage is preferably at least in part calcium depleted milk protein concentrate (MPC) or a mixture of calcium depleted milk protein concentrate (MPC) and non-calcium depleted milk protein concentrate (MPC).

Preferably the casein is only provided by calcium depleted milk protein concentrate (MPC) or a mixture of calcium depleted milk protein concentrate (MPC) and non-calcium depleted milk protein concentrate (MPC). In such an embodiment, the calcium depleted milk protein concentrate (MPC) preferably has greater than about 1 to 100% w/w calcium depletion, about 10 to 100% w/w calcium depletion, about 10 to 95% w/w calcium depletion. Where a mixture is used the overall combined calcium to casein ratio is as described above. Preferably the casein is only provided by a calcium depleted milk protein concentrate (MPC). In such cases, preferably the MPC has about 5-45% w/w calcium depletion or about 10-40% w/w calcium depletion. Where only a calcium depleted milk protein concentrate (MPC) is used as the source of casein, no blending of casein sources is required, which allows of easier manufacturing.

The term milk protein concentrate (MPC) refers to a milk protein product in which preferably between about 40%-90% w/w of the non-fat solids are protein, or between about 70%-90% w/w, preferably or between about 80% w/w-90% w/w, or between about 85% w/w-90% w/w of the non-fat solids are protein and the weight ratio of casein to whey proteins is between about 85:15 and about 50:50, or between about 85:15 and about 70:30, or between about 85:15 to about 80:20.

The term milk protein isolate refers to a milk protein product with greater than 90% milk protein on a solids non-fat basis and the weight ratio of casein to whey proteins is between about 85:15 and about 50:50, or between about 85:15 and about 70:30, or between about 85:15 to about 80:20.

The term micellar casein refers to a milk protein product with greater than 85:15 casein to whey ratio, or a weight ratio of casein to whey proteins is between about and about 100:0, and preferably between about 40%-95% w/w of the non-fat solids are protein, or between about 70%-95% w/w, preferably or between about 80-95% w/w, or between about 85-95% w/w of the non-fat solids are protein.

MPC can be produced by processes involving ultrafiltration and/or microfiltration either to prepare a stream enriched in casein or a stream enriched in whey protein, or a stream enriched in both casein and whey protein. Another process will include the blending of a stream of whey protein concentrate with skim milk with or without subsequent ultrafiltration.

The percentage of whey protein and casein in an MPC can vary, for example seasonally, or if the whey and casein are separated and then recombined the ratio can be set for the desired usage.

Calcium depleted MPCs are MPCs in which the calcium content is lower than the corresponding non-depleted MPC. Examples of preparation of a calcium depleted MPC can be found in WO01/41578, WO2017/087878 and/or US2015/0250195.

The calcium depleted MPC may be prepared from a standard MPC by removing calcium ions, for example by a method chosen from at least one (1) cation exchange on an ion exchanger charged with a single or multiple species of monovalent cation, (2) acidification to pH 4.6-7 with subsequent dialysis and/or ultrafiltration and/or diafiltration.

The calcium-depleted MPC may also be prepared by providing a low fat milk solution, for example skim milk, in liquid form and removing the calcium ions therein by a method chosen from at least of (1) cation exchange on an ion exchanger (for example a resin) bearing one or more monovalent cation species, or (2) acidification to pH 4.6-7 optionally with subsequent dialysis; and concentrating the solution obtained by ultrafiltration, optionally with diafiltration, to form an MPC having at least 40% dry weight of protein.

Some of the casein sources comprise whey protein. Where whey is present, the whey protein may optionally be heat treated to denature at least a portion of the whey protein. Where an MPC is used, the MPC may be optionally heat treated to denature at least a portion of the whey protein in the MPC.

Optionally, the MPC has about 50-100% denatured whey protein, or about 80-90% denatured whey protein, or about 70-100% denatured whey protein, or about 80-90% denatured whey protein.

In an MPC, the optional whey protein denaturation can be achieved by heating at a range of temperature (for example about 75° C. to 120° C.) and time combinations based on whey protein denaturation kinetics (J. Agric. Food Chem. 1996, 44, 2, 422-428). Based on the temperature, the heating time can be selected to achieve the targeted whey protein denaturation, or alternatively, based on the heating time the required temperature can be selected. The heat treatment can be done at two different stages in the process of making the MPC, for example:
1. heat treating the milk before ultrafiltration or microfiltration and optional calcium depletion
2. heat treating the retentate after ultrafiltration or microfiltration and optional calcium depletion

There are two main types of heat treatment systems, direct and indirect. Example of direct heating systems are (i) Steam injection systems (steam injected into product), (ii) steam infusion systems (product introduced into a steam-filled vessel).

Examples of indirect systems can be based on (i) plate heat exchangers, (ii) tubular heat exchangers, (iii) scraped surface heat exchangers.

Heating can be done in a continuous, batch and/or semi-batch systems. Examples of batch/semi batch are (i) batch processing in autoclaves, (iii) hydrostatic vertical sterilizer, (iii) horizontal rotary valve-sealed sterilizer.

The MPC is preferably dried to a moisture content of less than 5%. Or a water activity level than facilitates storage of the dry ingredient for several months without undue deterioration.

Micellar casein (also known, amongst others as micellar casein isolate, micellar casein concentrate, or native phosphocaseinate) may be produced from milk by microfiltration with a pore size of approximately 0.1 micron to allow the removal of whey protein, soluble salts and lactose. It can also be made from skimmed milk using a combination of microfiltration and ultrafiltration. The order of the steps can be changed depending on process needs and target composition of the final ingredient.

Whole milk powder (WMP) also referred as full cream milk powder is produced from whole milk, standardized to give a fat content of about 25-28% w/w in the powder. WMP is produced by concentrating (usually by evaporation) the milk to about 45-50% w/w total solids and then spray drying.

Skim milk powder (SMP) is produced by removing the cream from the whole milk to obtain skimmed milk. The skimmed milk is then concentrated, and spray dried to its final composition.

Depending on the source of casein used, the beverage may comprise about 0-5% w/w lactose and/or products of lactose hydrolysis, or about 0-4% w/w lactose and/or products of lactose hydrolysis, or about 0-3% w/w lactose and/or products of lactose hydrolysis or about 0-2% w/w lactose and/or products of lactose hydrolysis, or about 0-1% w/w lactose and/or products of lactose hydrolysis. It may be preferred for some applications that lactose and/or products of lactose hydrolysis are absent or at low levels. Preferably the products of lactose hydrolysis are glucose and/or galactose.

### Stability

The beverage preferably has a shelf life of at least 3 months, or at least 4 months, or at least 5 months, or at least 6 months, or at least 1 year.

The beverage preferably produces less than about 2 g/200 mL of sediment when stored at about 25° C. for 3 months, or less than about 1.5 g/200 mL of sediment when stored at about 25° C. for 3 months, or less than about 1 g/200 mL of sediment when stored at about 25° C. for 3 months.

The beverage preferably produces less than about 2 g/200 mL of sediment when stored at about 25° C. for 6 months, or less than about 1.5 g/200 mL of sediment when stored at about 25° C. for 6 months, or less than about 1 g/200 mL of sediment when stored at about 25° C. for 6 months, or less than about 0.5 g/200 mL of sediment when stored at about 25° C. for 6 months.

The beverage may change in viscosity or increases in viscosity, by equal to or less than 10 cP measured at a temperature of 20° C. and shear rate of 100 s⁻¹ when stored at about 25° C. for 3 months or by equal to or less than 8 cP measured at a temperature of 20° C. and shear rate of 100 s⁻¹ when stored at about 25° C. for 3 months or by equal to or less than 5 cP measured at a temperature of 20° C. and shear rate of 100 s⁻¹ when stored at about 25° C. for 3 months or by equal to or less than 3 cP measured at a temperature of 20° C. and shear rate of 100 s⁻¹ when stored at about 25° C. for 3 months, or equal to or less than 2 cP measured at a temperature of 20° C. and shear rate of 100 s⁻¹ when stored at about 25° C. for 3 months, or by equal to or less than 1.5 cP measured at a temperature of 20° C. and shear rate of 100 s⁻¹ when stored at about 25° C. for 3 months.

Alternatively, the beverage may change or increase in viscosity between 1 month of storage and 3 or 6 months of storage at about 25° C. by equal to or less than 10 cP measured at a temperature of 20° C. and shear rate of 100 s⁻¹, or by equal to or less than 8 cP, or by equal to or less than 5 cP, or by equal to or less than 3 cP, or by equal to or less than 2 cP, or by equal to or less than 1.5 cP measured at a temperature of 20° C. and shear rate of 100 s⁻¹.

The beverage is preferably stored in capped plastic, glass, or plasticized cardboard (for example Tetra Pak Tetra Brik) containers when stability testing is carried out, preferably capped polyethylene terephthalate (PET) containers. Preferably the beverage is stored in 200 mL plastic containers when the stability testing is carried out. Preferably the beverage is stored in capped PET 200 mL containers when the stability testing is carried out.

Testing for sedimentation uses the following procedure: containers of the beverage are stored at about 25° C.; container is placed upside down for 30 minutes; the weight of the container plus sediment is recorded; the weight of the empty container is subtracted from the weight of the container plus sediment.

### Stabilizers Not Used in the Beverage

The beverage, sterilized beverage or process to make a beverage does not substantially use or does not use a stabilizing amount of stabilizers (i) polysaccharide thickener (as defined in this specification), or (ii) calcium chelator (as defined in this specification), i.e. neither type of stabilizer (polysaccharide thickener and calcium chelator) or alternatively selections from neither of these types are used.

If either one of a polysaccharide thickener or calcium chelator are not present in a beverage, it would be expected that the other would be necessary in order to compensate for the lack of one type of stabilizer. It is therefore surprising that the beverage is stable without both types of stabilizer (as defined in the specification).

In some embodiments the polysaccharide thickener stabilizer, and the calcium chelator stabilizer excluded from the beverage is as defined below. In such cases, while some forms of stabilizer may still be used in the beverage, it is still advantageous to be able to make a beverage with less stabilizers, such that the ingredients list for the beverage is shorter, which is preferred by many consumers.

The polysaccharide thickener excluded from the beverage is preferably one or more of gellan, carboxymethyl cellulose (CMC), microcrystalline cellulose (MCC), and carrageenan.

Alternatively the polysaccharide thickener excluded from the beverage consists of the group gellan, carboxymethyl cellulose (CMC), microcrystalline cellulose (MCC), and carrageenan.

Alternatively the polysaccharide thickener excluded from the beverage consists of the group: a starch, gellan, carrageenan, xanthan, carboxymethyl cellulose (CMC), microcrystalline cellulose (MCC), guar, pectin, an alginate, agar, locust bean gum, gum Arabic, tragacanth, karaya gum.

Alternatively the polysaccharide thickener excluded from the beverage consists of the group: E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch), E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate) and/or is E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose).

Alternatively the polysaccharide thickener excluded from the beverage consists of the thickeners in the E number range E1400-E1500 and/or in the range E400-E441, E460-E469;

Alternatively the polysaccharide thickener excluded from the beverage consists of the group food safe polysaccharide thickeners;

The calcium chelator excluded from the beverage is preferably potassium citrate.

Alternatively the calcium chelator excluded from the beverage consists of the group monovalent mineral salts of phosphate and citrate.

Alternatively the calcium chelator excluded from the beverage consists of the E numbers E339, E340, E365, E450-452, E 391.

Alternatively the calcium chelator excluded from the beverage consists of the group: E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate).

Alternatively the calcium chelator excluded from the beverage consists of the group: glycerophosphate, uridine monophosphate, cytidine monophosphate, orthophosphate, inositol hexaphosphate, hexametaphosphate, disodium uridine monophosphate, disodium cytidine monophosphate, disodium orthophosphate, inorganic orthophosphate, sodium phytate, potassium phosphates, diphosphates, triphosphates, dodecasodium inositol hexaphosphate, organic polyphosphate, polyphosphates, hexasodium hexametaphosphate, soluble phosphate salt, soluble citrate salt, long-chain phosphate, tripolyphosphate, pyrophosphate, citrate, orthophosphate, tri potassium citrate, tri sodium citrate, ribonucleotide, thymidine monophosphate, guanosine monophosphate, adenosine monophosphate, inosine monophosphate, uridine diphosphate, cytidine diphosphate, thymidine diphosphate, guanosine diphosphate, adenosine diphosphate, inosine diphosphate, uridine triphosphate, cytidine triphosphate, thymidine triphosphate, guanosine triphosphate, adenosine triphosphate, inosine triphosphate.

Alternatively the calcium chelator excluded from the beverage consists of the group: food safe calcium chelators.

Where the calcium chelator is a salt, it is preferably a monovalent mineral salt (i.e. monovalent cation, for example sodium, potassium, ammonium). Where the calcium chelator is a salt, it is preferably not a calcium or magnesium salt, as these will not be as effective calcium chelators.

For the avoidance of doubt, any one of the alternative definitions for the polysaccharide thickener may be combined with any one of the alternative definitions for the calcium chelator.

In some instances, where it is not specially excluded, it may be beneficial for the beverage to include about 0-5% w/w polysaccharide thickener. For example, the beverage may comprise about 0-2% w/w polysaccharide thickener or about 0-1% w/w polysaccharide thickener or about 0.01-1% w/w polysaccharide thickener or about 0.05-0.5% w/w polysaccharide thickener. Alternatively the beverage may comprise at least about 0.01 to about 1, or 0.5 or 0.3% w/w polysaccharide thickener.

In such cases the polysaccharide thickener may be selected from:
A. the polysaccharide thickener may be selected from one or more food safe polysaccharide thickeners.
B. the polysaccharide thickener may be selected from any one or more of E number range E1400-E1500 and/or in the range E400-E441, E460-E469.
C. the polysaccharide thickener may be selected from any one or more of E1400 (Dextrin, Dextrins, roasted starch white and yellow), E1401 (Modified starch, Acid-treated starch), E1402 (Alkaline modified starch), E1403 (Bleached starch), E1404 (Oxidized starch), E1405 (Enzyme treated starch), E1410 (Monostarch phosphate), E1411 (Distarch glycerol), E1412 (Distarch phosphate, starch cross linked with sodium trimetasphosphate or phosphorus oxychloride), E1413 (Phosphated distarch phosphate), E1414 (Acetylated distarch phosphate), E1420 (Starch acetate esterified with acetic anhydride), E1421 (Starch acetate esterified with vinyl acetate), E1422 (Acetylated distarch adipate), E1423 (Acetylated distarch glycerol), E1430 (Distarch glycerine), E1440 (Hydroxy propyl starch),

E1441 (Hydroxy propyl distarch glycerine), E1442 (Hydroxy propyl distarch phosphate), E1443 (Hydroxy propyl distarch glycerol), E1450 (Starch sodium octenyl succinate), E1451 (Acetylated oxidised starch), E1452 (Starch aluminium octenyl succinate),

and/or E400 (alginic acid), E401 (sodium alginate), E402 (potassium alginate), E403 (ammonium alginate), E404 (calcium alginate), E405 (propane-1,2-diol alginate), E406 (agar), E407 (carrageenan), E407a (processed eucheuma seaweed), E408 (Bakers yeast glycan), E409 (Arabinogalactan), E410 (Locust bean gum (Carob gum)), E411 (Oat gum), E412 (Guar gum), E413 (Tragacanth), E414 (Acacia gum (gum arabic)), E415 (Xanthan gum), E416 (Karaya gum), E417 (Tara gum), E418 (Gellan gum), E419 (Gum ghatti), E425 (Konjac, Konjac gum, Konjac glucomannane), E426 (Soybean hemicellulose), E427 (Cassia gum), E440 (Pectins, pectin, amidated pectin), E441 (Gelatine), E460 (Cellulose, Microcrystalline cellulose, Powdered cellulose), E461 (Methyl cellulose), E462 (Ethyl cellulose), E463 (Hydroxypropyl cellulose), E464 (Hypromellose (hydroxypropyl methylcellulose)), E465 (Ethyl methyl cellulose), E466 (Carboxymethyl cellulose, Sodium carboxymethyl cellulose), E467 (Ethyl hydroxyethyl cellulose), E468 (Crosslinked sodium carboxymethyl cellulose (Croscarmellose)), E469 (Enzymically hydrolysed carboxymethylcellulose).
D. the polysaccharide thickener may be selected from any one or more of a starch, gellan, carrageenan, xanthan, carboxymethyl cellulose (CMC), microcrystalline cellulose (MCC), guar, pectin, alginate, agar, locust bean gum, gum Arabic, tragacanth, karaya gum.
E. the polysaccharide thickener may be selected from any one or more of gellan, carboxymethyl cellulose (CMC), microcrystalline cellulose (MCC), and carrageenan.

### Protein

The beverage or sterilized beverage or process to make a beverage preferably comprises about 4-15% w/w casein or about 5-15% w/w casein, or about 6-15% w/w casein or about 6-13% w/w casein or about 6-12% w/w casein.

Where it is not specially excluded, it may be beneficial to include a polysaccharide thickener in the beverage where the amount of casein is at a higher level. For example, when a polysaccharide thickener is included the beverage may comprises about 8-15% w/w casein or about 8-13% w/w casein or about 8-12% w/w casein.

The beverage or sterilized beverage or process to make a beverage preferably comprises about 4.5 to 19% w/w milk protein, or about 5-19% w/w milk protein, or about 5-17% w/w milk protein, or about 5-15% w/w milk protein, or about 7-15% w/w milk protein, or about 8-15% w/w milk protein, or about 10-15% w/w milk protein. Depending on the casein source, the milk protein may only contain casein (in various forms) or may also comprise whey. Whey is considered a high value, quality protein, so casein sources that include whey may be preferred, depending on the use for the beverage. The beverage/sterilized beverage preferably comprises about 0-2% w/w whey protein, either from the casein source or added as a further component. The beverage/sterilized beverage preferably comprises about 0.01-2% w/w whey protein, or about 0.05-2% w/w whey protein, or about 0.1-2% w/w whey protein, or about 0.5-2% w/w whey protein, or about 1-2% w/w whey protein.

The beverage/sterilized beverage may further comprise additional protein sources added, such as vegetable protein and/or collagen and/or these may be added in the process of making a beverage.

### Carbohydrate

The beverage/heat sterilized beverage or process to make a beverage comprises about 0-30% w/w carbohydrate in the beverage. Preferably, about 0-20% w/w carbohydrate, or about 0 to 10% w/w carbohydrate, or about 0 to 5% w/w carbohydrate, or about 0 to 2% w/w carbohydrate. Alternatively, the beverage, heat sterilized beverage or process to make a beverage comprises about 10 to 30% w/w carbohydrate. The amount of carbohydrate can be selected according to the use of the beverage, for example a beverage for medical/convalesces preferably comprises about 10 to 30% w/w carbohydrate, whereas a beverage for sport/muscle development preferably has lower carbohydrate.

Depending on the casein used it may have some carbohydrate. An additional source of carbohydrate may include digestible carbohydrates. The carbohydrate may comprise monosaccharides, disaccharides, oligosaccharides and polysaccharides and mixtures thereof. Oligosaccharides of glucose are typically used. A number of these are commercially available as maltodextrin (3-20 dextrose equivalent (DE)) or corn syrup for the longer chain carbohydrates (>20 DE).

Non-digestible carbohydrates (fibre) may also be included, for example, fructooligosaccharides, inulin, and galactooligosaccharides. Preferably the additional source of carbohydrate is inulin. Non-digestible carbohydrates are used for health purposes, they will not or only slightly contribute to the energy provided by the beverage/sterilized beverage.

Preferably about 7-100% of the energy provided by the beverage is provided by protein, or about 10-30% of the energy provides by the beverage is provided by protein, or about 60-100% of the energy provides by the beverage is provided by protein.

### Fat

The beverage comprises about 0-15% w/w fat, or about 0-14% w/w fat, or about 0-13% w/w fat, or about 0-12% w/w fat, or about 0-10% w/w fat. Preferably for low fat beverage, such as sports beverages, the beverage comprises about 0-5% w/w fat, or about 0-2% w/w fat, or about 0-1.5% w/w fat. Alternatively, for higher fat beverages, for example medical beverages, the beverage preferably comprises about 5-15% w/w fat, or about 5-12% w/w fat, or about 5-10% w/w fat, or about 5-8% w/w fat.

Preferably the fat is oil, for example the fat is vegetable oil or a dairy fat (for example anhydrous milk fat (AMF)).

### Vitamin, Minerals and Other Additives

The beverage may comprise one or more additional minerals and/or vitamins. Minerals and/or vitamins may be added to meet regulatory requirements. The solubility and particle sizes of the added minerals needs to be considered in designing the beverage. Where soluble (at the pH of the beverage) calcium is added as an additional mineral, the amount added will be within the overall stated casein to calcium ratio. If insoluble calcium salts are included in the beverage, the calcium will not be soluble so will not affect the casein to calcium ratio. If insoluble calcium or other insoluble salts (at the pH of the beverage) are added, they will form sediment during storage if the mineral particle size is larger, so smaller particle sizes are preferred. Further, an insoluble or barely soluble (at the pH of the beverage) citrate, phosphate and/or tartrate will not provide a stabilising amount of chelator. For example, dimagnesium phosphate has low solubility so it is unlikely that a stabilising amount of phosphate would dissolve to interact with calcium, unless large quantities of dimagnesium phosphate were added to the beverage, however, such quantities would likely form sediment and would not be desirable.

If additional magnesium or calcium sources are required, preferably the beverage comprises one or more of: di magnesium phosphate, calcium carbonate, potassium chloride, calcium phosphate, magnesium hydroxide, magnesium chloride, sodium chloride, calcium hydroxide, magnesium oxide.

The beverage may optionally comprise lecithin (for example about 0.01-1% w/w) and/or other components. Other components that may be added to a dairy protein beverage will be known to a person skilled in the art.

The beverage preferably has total solids of about 4 to 60% w/w, or about 5 to 50% w/w, or about 5 to 40% w/w, or about 5 to 30% w/w, or about 10 to 30% w/w. The total solids is the combined percentage w/w of the fat, carbohydrate, protein and ash and would be understood by a person skilled in the art.

### Heating/Sterilization

The sterilized beverage or the process of making a beverage preferably includes sterilization. The sterilization can comprise heat treating the beverage to sterilize the beverage. Preferably high temperature sterilizing is used. The high temperature sterilization step is preferably carried out at about 90° C. to about 150° C. for about 0.25 second to about 60 minutes.

Preferably the high temperature sterilizing step comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, 60 seconds or at least about 1, 2, 3, 4, 5, 6, 7, 8, 9, 10 or at least about 60 minutes. Various ranges can be selected from between any of these values, for example, in various embodiments the high temperature sterilizing step comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 s to about 10 minutes, about 0.1 s to about 1 minute, about 0.1 s to about 30 s, about 0.5 s to about 30 s, about 1 s to about 30 s, about 3 s to about 30 s about 0.1 s to about 20 s, about 0.5 to about 20 s, about 1 to about 20 s, about 3 to about 20 s, about 0.1 to about 10 s, about 1 to about 10 s, about 3 to about 10 s, about 0.1 to about 7 s, about 1 to about 7 s, about 3 to about 7 s, about 0.1 to about 5 s, about 1 to about 5 s or about 3 s to about 5 s.

In various embodiments the high temperature sterilizing step comprises heat treating the beverage at a temperature of at least about 115° C. for at least about 2 s, at least about 120° C. for at least about 2 s, at least about 125° C. for at least about 2 s, at least about 130° C. for at least about 1 s, at least about 135° C. for at least about 1 s, at least about 138° C. for at least about 1 s, at least about 130° C. for at least about 3 s, at least about 135° C. for at least about 3 s, at least about 138° C. for at least about 3 s, from about 130 to about 150° C. for at least about 1 s, from about 130 to about 150° C. for at least about 3 s, from about 135 to about 150° C. for at least about 1 s, from about 135 to about 150° C. for at least about 3 s, from about 138 to about 145° C. for at least about 1 s, from about 138 to about 145° C. for at least about 3 s, at least about 130° C. for about 1 s to about 10 s, at least about 135° 5 C for about 1 s to about 10 s, at least about 138° C. for about 1 s to about 10 s, from about 135 to about 150° C. for about 1 s to about 10 s, from about 138 to about 145° C. for about 1 s to about 10 s, from about 135 to about 150° C. for about 3 s to about 5 s, or from about 138 to about 145° C. for about 3 s to about 5 s.

The high temperature sterilizing preferably gives an Fo value of at least about 5, or at least about 3. Preferably the heat treatment has an Fo value of at least equivalent to 90° C. for 40 s, 121.1° C. for 3 min, 130° C. for 25 s, 140° C. for 2.5 s or 150° C. for 0.25 s

Preferably the high temperature sterilizing is carried out by UHT or retort.

The sterilized beverage is optionally cooled under aseptic conditions and/or aseptically packaged.

### pH of Beverage

The pH of the beverage may be or may be adjusted to be about 6.5-7.4 or about 6.6-7.2, or about 6.6-7.0, or about 6.7-6.9. If the pH is adjusted it may be adjusted with the addition of an acidity regulator, which may be an acid and/or a base which are food safe. Examples of acidity regulators include any one or more of sodium hydroxide, potassium hydroxide, lactic acid, acetic acid, malic acid, fumaric acid, tartaric acid. It is believed having a pH within these ranges contributes to heat stability of the beverage.

### Homogenising Step

Preferably the process of making a beverage/heat sterilized beverage comprises homogenised the mixture. Preferably the homogenising pressure used is a total of about 100 to about 1000 bars, or about 100 to about 600 bars or about 100 to about 500 bars, or about 100 to about 400 bars. The homogenisation can be done in multiple passes, for example two passes. In this case the total pressure is the sum of the pressure of the stages, for example in one pass, first stage 100 bar and second stage 40 bar (100/40 bar) gives a total of 140 bar. For example, two passes with the same two stages will give a total of 280 bar.

### Other Process Steps

Preferably the aqueous mixture is warmed to facilitate mixing, preferably when using dry ingredients, after they are added to the water/aqueous mixture.

The sterilized beverage is preferably cooled under aseptic conditions, and/or is aseptically packaged.

The beverage is preferably packaged in capped plastic, glass, or plasticized cardboard (for example Tetra Pak Tetra Brik) containers. The beverage is preferably packaged in capped polyethylene terephthalate (PET) containers, for example capped 200 mL plastic containers or capped PET 200 mL containers. However, other suitable storage containers for the beverage or to be used in the process will be known to a person skilled in the art.

Where, in the foregoing description reference has been made to integers or components having known equivalents thereof, those integers are herein incorporated as if individually set forth.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

### EXAMPLES

### 1. Example 1: Process for Preparation of Beverages and Measurement of Shelf Life/Sediment

Four different beverages were prepared using three different milk protein concentrates (MPCs) to test and compare their stability and/or amount of sediment and cream formed during storage.

The compositions/descriptions of the MPCs are shown in Table 1.

The calcium depleted MPCs (MPC A and MPC C) were prepared as described in in U.S. Pat. No. 7,157,108. Calcium depleted MPC retentate was heat treated at a temperature/time combination of 90° C./4 s and then evaporated and dried to produce the heated treated MPC C. The whey protein denaturation from the heating step was about 30%.

TABLE 1

| Composition | | MPC B | |
|---|---|---|---|
| (per 100 g) | MPC A | (control) | MPC C |
| Protein (g) | 84.6 | 81.1 | 82.5 |
| Moisture (g) | 2.4 | 5.7 | 5.3 |
| Fat (g) | 1.2 | 1.5 | 1.5 |
| Lactose (g) | 4.3 | 5.0 | 3.8 |
| Ash (g) | 7.5 | 6.7 | 6.9 |
| Calcium (mg) | 1770 | 2160 | 1330 |
| Sodium (mg) | 318 | 70 | 1005 |
| Casein | 67.7 | 64.9 | 66.0 |
| Calcium to | 2.6 | 3.3 | 2.0 |
| 100 g casein | | | |
| ratio | | | |
| Description | Calcium-depleted | Standard milk protein | Calcium-depleted milk |
| | milk protein | concentration (MPC) - | protein concentrate (MPC) |
| | concentrate (MPC) | not calcium depleted | that has undergone a |
| | that has 18% by | | heat treatment to at least |
| | weight of the | | 80° C. and has 38% by |
| | calcium removed | | weight of the calcium |
| | | | removed |

The quantities of the ingredients in the beverages is shown in Table 2.

TABLE 2

| | | | Beverage | |
|---|---|---|---|---|
| | | Beverage | 3 | |
| | | 2 | (with citrate - | |
| Ingredients | Beverage | (comparative | comparative | Beverage |
| (% w/w) | 1 | beverage) | beverage) | 4 |
| Water | 87.8 | 87.2 | 87.1 | 87.5 |
| MPC A | 10.8 (7.3 | | | |
| | casein) | | | |
| MPC B | | 11.4 (7.3 | 11.4 (7.3 | |
| (control) | | casein) | casein) | |
| MPC C | | | | 11.19 (7.3 |
| | | | | casein) |
| Canola oil | 0.7 | 0.7 | 0.7 | 0.7 |
| Inulin | 0.35 | 0.35 | 0.35 | 0.35 |
| Di Magnesium | 0.14 | 0.12 | 0.12 | 0.16 |
| phosphate 3 | | | | |
| hydrate | | | | |
| (insoluble | | | | |
| mineral) | | | | |
| Lecithin | 0.1 | 0.1 | 0.1 | 0.1 |
| Tri-potassium | 0 | 0 | 0.27 | 0 |
| citrate | | | | |
| monohydrate | | | | |

The nutritional information for the beverages are shown in Table 3.

TABLE 3

| | | | Beverage | |
|---|---|---|---|---|
| | | Beverage | 3 | |
| | | 2 | (with citrate - | |
| | Beverage | (comparative | comparative | Beverage |
| per 100 ml | 1 | beverage) | beverage) | 4 |
| Energy (Cal) | 50.5 | 50.9 | 50.2 | 50.2 |
| Protein (g) | 9.6 | 9.6 | 9.6 | 9.6 |
| Fat (g) | 1 | 1 | 1 | 1 |
| Carbohydrate (g) | 1 | 0.95 | 0.8 | 0.8 |
| Energy coming | 76% | 75% | 76% | 76% |
| from protein (%) | | | | |

The beverages were prepared using the following procedure:

### Procedure:

1. All dry ingredients i.e. dry blend protein, inulin and powdered lecithin, were pre weighed
2. RO water required (minus 500 ml to be used to dissolved minerals) for each batch into 20 L stainless steel vessel was weigh out and heated to 55-60° C. with overhead stirrers in water bath.
3. Dry-blended powder was added slowly, over a period of 15 minutes, into the stainless-steel vessels.
4. The minerals (Di Magnesium phosphate and Tripotassium citrate) were pre dissolved for each batch at 55-60° C. for 5 minutes in 500 ml water and add into the stainless-steel vessels.
5. The mixture was then stirred at 57° C.±2° C. for 60 minutes
6. Oil was added to each vessel and ultraturrex at 7,000 rpm along with stirring for 3 minutes.
7. Water was added if required to the beverage to obtain a final weight of 20 kg.
8. The mixture was heat to 60° C. and pass through a two-stage homogeniser once at 150/50 bar (200 total).
9. The product was cooled to ˜25° C. for pH measurement using PHE
10. pH was adjusted to 6.8 if necessary, using 2.5% citric acid (citric acid was used only for comparative beverages 2 and 3)
11. The mixture was UHT processed at about 145° C. for 4 or 5 sec and then packed aseptically. The preheating temperature was between 80-83° C. and achieved using a plate heat exchanger. The product was held for 30 seconds at this temperature. The final heat treatment temperature was then raised to 144-146° C. using plate heat exchanger (indirect heat treatment). The first stage of cooling was to 70-76° C. using a flash vessel and the final cooling was to about 20-25° C. using a plate heat exchanger.
12. The product was immediately packed at about 24-25° C. into 200 mL PET bottles and capped.
13. The product was then stored at about 25° C.

After the various time periods, the sediment that had formed was measured according to the following procedure:
1. Inspect the product for any signs of creaming, draw a score line and measure in millimetres.
2. Shake (invert vigorously) the pottle, bottle or tetra pack 6 times, pour all contents of sample into new clean container.
3. The liquid is then drained from container leaving the sediment in the container.
4. When all samples from batch have been poured, place containers or packs upside down on handy towels to drain for 30 minutes
5. Weight of the container plus sediment is then recorded.
6. Container is then washed and re-weighed which is the weight of the empty container.
7. Sediment weight g per 200 ml of beverage is calculated as (weight of sediment+container) minus (weight of container divided by the weight)

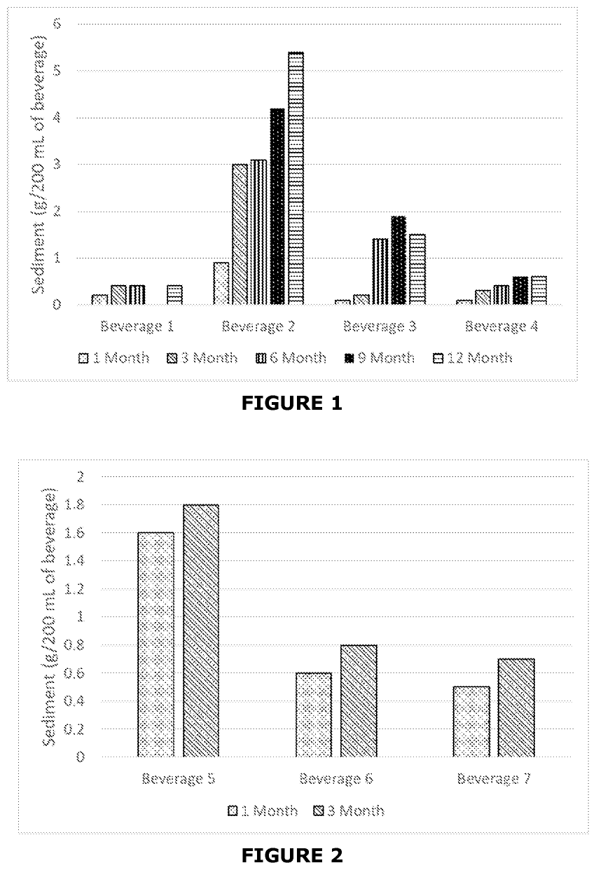

The results of the sedimentation testing are shown in FIG. 1 and Table 4. No creaming was observed for the four beverages. The results of viscosity testing are show in Table 5.

TABLE 4

| | Sediment (g/200 ml of beverage) | | | | |
|---|---|---|---|---|---|
| | 1 | 3 | 6 | 9 | 12 |
| Beverage number | Month | Month | Month | Month | Month |
| Beverage 1 | 0.2 | 0.4 | 0.4 | — | 0.4 |
| Beverage 2 | 0.9 | 3.0 | 3.1 | 4.2 | 5.4 |
| (comparative beverage - | | | | | |
| MPC not calcium | | | | | |
| depleted - no citrate) | | | | | |
| Beverage 3 | 0.1 | 0.2 | 1.4 | 1.9 | 1.5 |
| (comparative beverage - | | | | | |
| with citrate) | | | | | |
| Beverage 4 | 0.1 | 0.3 | 0.4 | 0.6 | 0.6 |

TABLE 5

| | Viscosity of beverage cP (measured at a | | | | |
|---|---|---|---|---|---|
| Beverage | temperature of 20° C. and shear rate of 100 s⁻¹) | | | | |
| number | 1 Month | 3 Month | 6 Month | 9 Month | 12 Month |
| Beverage 1 | 4.53 | 4.74 | 4.89 | | 4.87 |
| Beverage 2 | 5.28 | 9.09 | 9.8 | 10.7 | 10.6 |
| Beverage 3 | 5.38 | 5.15 | | 5.99 | 6.34 |
| Beverage 4 | 7.49 | 8.37 | 9.22 | 11.0 | 10.0 |

The comparative beverage 2 made from MPC B (control without stabilizers) has about 3 g/200 mL of sediment after 3 months and 3.1 g/200 mL after 6 months. This shows the expected sedimentation for a protein beverage when stabilizers are not used.

The comparative beverage 3 made using tri-potassium citrate chelating agent as a stabilizer has less than 0.5 g/200 mL sediment after 3 months of storage but 1.4 g/200 mL of sediment after 6 months.

It can be seen that beverages 1 and 4 surprisingly have less than 0.5 g/200 mL sediment after 3 months or 6 months of storage. These beverages therefore provide comparable or even better shelf life or sediment retardation but without the use of a chelating agent or polysaccharide stabilizer.

### 2. Example 2: Process for Preparation of Beverages and Measurement of Shelf Life Sediment

Beverages were prepared using MPC D with added protein sources. The compositions/description of the proteins are shown in Table 6.

TABLE 6

| | | Whey | Skim | Soy |
|---|---|---|---|---|
| | | Protein | milk | protein |
| Composition | | Concentrate | powder | isolate |
| (per 100 g) | MPC D | WPC A | SMP A | SPI A |
| Protein (g) | 80.5 | 78.76 | 35 | 90 |
| Moisture (g) | 5.7 | 4 | 3.8 | 7 |
| Fat (g) | 1.4 | 5.1 | 0.8 | 0.8 |
| Lactose (g) | 5.5 | 9.24 | 52.6 | 0 |
| Ash (g) | 6.9 | 2.9 | 7 | 6 |
| Calcium (mg) | 1900 | 273 | 1240 | 20 |
| Sodium (mg) | 400 | 587 | 390 | 1350 |
| Casein | 64.4 | — | 28 | — |
| Calcium to | 3.0 | — | 4.4 | |
| 100 g casein | | | | |
| ratio | | | | |
| Description | Calcium-depleted | Whey | De- | Protein |
| | milk protein | protein | fatted | isolated |
| | concentrate | prepared | dried | from |
| | (MPC) that has | by heat | milk | soybeans |
| | 12% by weight of | treatment | | with a high |
| | the calcium | | | protein |
| | removed | | | content |

The quantities of the ingredients in the beverages is shown in Table 7.

TABLE 7

| | Beverage 5 | Beverage 6 | Beverage 7 |
|---|---|---|---|
| Ingredients | MPC D + | MPC D + | MPC D + |
| (% w/w) | WPC | SMP | SPI |
| Water | 87.6 | 87.36 | 87.44 |
| MPC D | 11.14 (7.17 | 11.28 (7.26 | 11.20 (7.21 |
| | casein) | casein) | casein) |
| WPC A | 0.4 | | |
| SMP A | | 0.5 (0.41 | |
| | | casein) | |
| SPI A | | | 0.5 |
| Canola oil | 0.75 | 0.75 | 0.75 |
| Lecithin | 0.1 | 0.1 | 0.1 |

The nutritional information for the beverages is shown in Table 8.

TABLE 8

| | Beverage | Beverage | Beverage |
|---|---|---|---|
| Per 100 ml | 5 | 6 | 7 |
| Energy (Cal) | 50.0 | 50.7 | 50.2 |
| Protein (g) | 9.28 | 9.25 | 9.46 |
| Fat (g) | 1.03 | 1.01 | 1.01 |
| Carbohydrate (g) | 0.55 | 0.78 | 0.51 |
| Calcium (mg) | 212 | 219 | 212 |
| Energy coming from protein (%) | 85.0 | 85.2 | 85.1 |
| Calcium to 100 g casein ratio | 3.0 | 3.0 | 2.9 |

The beverages were prepared using the following procedure:

### Procedure:

1. All dry ingredients i.e. dry blend of protein and powdered lecithin, were pre weighed
2. RO water required for each batch was weighed out into 20 L stainless steel vessels and heated to 50-55° C. with overhead stirrers in a water bath.
3. Dry-blended powder was added slowly, over a period of 15 minutes, into the stainless-steel vessels.
4. The mixture was then stirred at 50° C.±2° C. for 60 minutes
5. Oil was added to each vessel and a coarse emulsion formed with an ultraturrex at 7,000 rpm along with stirring for 3 minutes.
6. Water was added, if required, to the beverage to obtain a final weight of 20 kg.
7. The mixture was heated to 60° C. and passed through a two-stage homogeniser once at 150/50 bar (200 total).
8. The product was cooled to ˜25° C. for pH measurement using a plate heat exchanger (PHE)
9. pH was monitored, but not adjusted
10. The product then underwent a preheating temperature of 75° C. and was achieved using a plate heat exchanger. The product was held for 30 seconds at this temperature. The mixture was UHT processed. The final heat treatment temperature was then raised to 144-146° C. using direct steam injection (direct heat treatment) for 4 or 5 sec. The first stage of cooling was to 70-76° C. using a flash vessel and the final cooling was to about 20-25° C. using a plate heat exchanger.
11. The product was immediately aseptically packed at about 24-25° C. into 200 mL PET bottles and capped.
12. The product was then stored at about 25° C.

After the various time periods, the sediment and creaming that had formed was measured according to the procedure described in Example 1:

The results of the sedimentation testing are shown in Table 9 and FIG. 2.

TABLE 9

| | |
|---|---|
| Beverage | Sediment (g/200 ml) of beverage |

| number | 1 Month | 3 Month |
|---|---|---|
| Beverage 5 | 1.6 | 1.8 |
| Beverage 6 | 0.6 | 0.8 |
| Beverage 7 | 0.5 | 0.7 |

The beverage 5 made from MPC D and whey protein concentrate has about 1.6 g/200 mL of sediment after 1 month of storage and 1.8 g/200 mL sediment after 3 months of storage. While this is higher than some of the other examples, this beverage contains whey which can cause sediment, and the sediment levels are still lower than comparative beverage 2 in Example 1 (MPC not calcium depleted—no citrate) and is comparable at 6 months to beverage 3 in Example 1 (comparative beverage with citrate). It can be seen that beverage 5 still had less than 2 g/200 mL sediment after 3 months of storage.

It can be seen that the beverages 6 (MPC D+SMP) and 7 (MPC D+SPI) surprisingly have less than 1 g/200 mL sediment after 1 month or 3 months of storage. Beverages 6 and 7 provided comparable or even better shelf life or sediment retardation to a beverage including a chelating agent (see for example beverage 3) but without the use of a chelating agent or polysaccharide stabilizer.

The viscosity of the beverages were measured and are shown in Table 10. The viscosities did not significantly increase over the course of the stability trials.

TABLE 10

| | |
|---|---|
| | Viscosity of beverage cP (measured at a |
| Beverage | temperature of 20° C. and shear rate of 100 s⁻¹) |

| number | 1 Month | 3 Month |
|---|---|---|
| Beverage 5 | 5.75 | 5.34 |
| Beverage 6 | 6.57 | 5.7 |
| Beverage 7 | 6.02 | 6.31 |

### 3. Example 3: Process for Preparation of Higher Calorie Beverages and Measurement of Shelf Life/Sediment

Three different high calorie beverages were prepared using MPC D to test and compare their stability and/or amount of sediment and cream formed during storage.

The compositions/description of the MPCs are shown in Table 11.

The calcium depleted MPC D was prepared as described in U.S. Pat. No. 7,157,108.

The quantities of the ingredients in the beverages is shown in Table 12.

TABLE 11

| Composition (per 100 g) | MPC D |
|---|---|
| Protein (g) | 80.5 |
| Moisture (g) | 5.7 |
| Fat (g) | 1.4 |
| Lactose (g) | 5.5 |
| Ash (g) | 6.9 |
| Calcium (mg) | 1900 |
| Sodium (mg) | 400 |
| Casein | 64.4 |
| Calcium to 100 g casein ratio | 3.0 |
| Description | Calcium-depleted milk protein |
| | concentrate (MPC) that has 12% by |
| | weight of the calcium removed |

TABLE 12

| | | | Beverage 10 |
|---|---|---|---|
| | | Beverage 9 | (comparative |
| Ingredients | | (comparative | with larger |
| (% w/w) | Beverage 8 | with citrate) | amount citrate) |
| Water | 54.36 | 54.52 | 54.32 |
| MPC D | 10.68 (6.88 | 9.87 (6.36 | 9.87 (6.36 |
| | casein) | casein) | casein) |
| Canola oil | 8.22 | 8.09 | 8.09 |
| Lecithin | 0.2 | 0.20 | 0.20 |
| Tri-potassium citrate | | 0.40 | 0.60 |
| monohydrate | | | |
| Maltodextrin | 25.33 | 23.77 | 23.77 |
| Granular sugar | 1.2 | 2.40 | 2.40 |
| Potassium hydroxide (5%) | | 0.60 | 0.60 |
| Magnesium chloride | | 0.14 | 0.14 |

The nutritional information for the beverages are shown in Table 13.

TABLE 13

| | Beverage | Beverage | Beverage |
|---|---|---|---|
| Per 100 ml | 8 | 9 | 10 |
| Energy (Cal) | 222 | 240 | 240 |
| Protein (g) | 8.90 | 9.60 | 9.60 |
| Fat (g) | 8.90 | 9.60 | 9.60 |
| Carbohydrate (g) | 26.65 | 28.96 | 28.96 |
| Energy coming from protein (%) | 17.6 | 15.1 | 15.1 |

The beverages were prepared using the general procedure outline in Example 2 for Beverage 8 and Example 1 for beverages 9 and 10. The maltodextrin and granular sugar were dry bended with the MPC in step 1. The magnesium chloride was added between step 3 and 4 (prior to mixing). In step 9 KOH was used for pH adjustment for beverage 9 and 10.

After the various time periods, the sediment and creaming that had formed was measured according to the procedure described in Example 1:

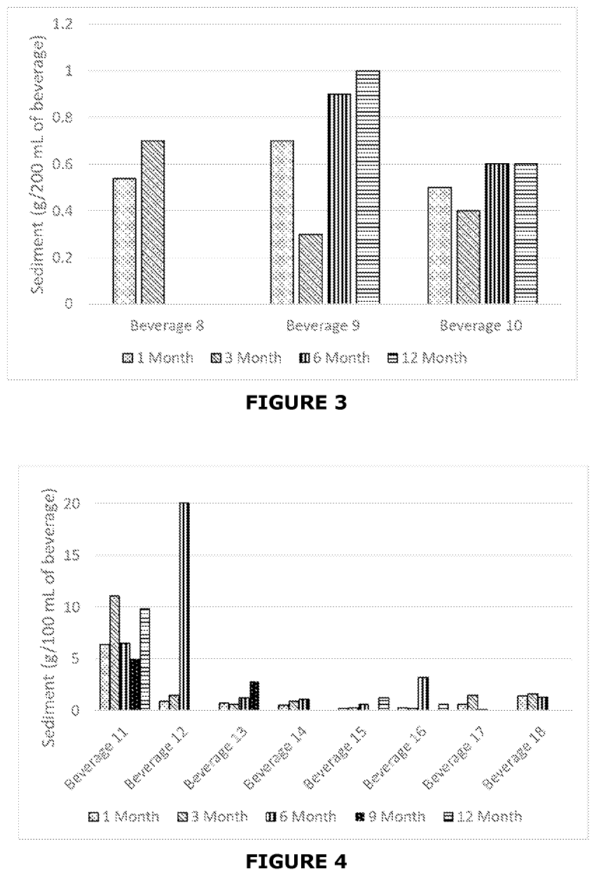

The results of the sedimentation testing are shown in Table 14 and FIG. 3.

TABLE 14

| | Sediment (g/200 ml) of beverage | | | | |
|---|---|---|---|---|---|
| | 1 | 3 | 6 | 9 | 12 |
| Beverage number | Month | Month | Month | Month | Month |
| Beverage 8 | 0.54 | 0.7 | | | |
| Beverage 9 | 0.7 | 0.3 | 0.9 | — | 1.0 |
| (comparative with | | | | | |
| citrate) | | | | | |
| Beverage 10 | 0.5 | 0.4 | 0.6 | — | 0.6 |
| (comparative with | | | | | |
| larger amount citrate) | | | | | |

It can be seen that the beverage 8 surprisingly had less than 1 g/200 mL sediment after 1 month or 3 months of storage. This beverage therefore provided comparable shelf life or sediment retardation to a beverage with similar composition that uses a calcium chelator (e.g. citrate) (for example beverage 9 or 10) but without the use of a chelating agent or polysaccharide thickener stabilizers.

### 4. Example 4—Further Beverage Compositions

Eight different beverages were prepared using three different milk protein concentrates (MPCs) to test and compare their stability and/or amount of sediment and/or cream formed during storage. The viscosity of the beverages over time was also measured.

The beverages were prepared according to the general procedure in Example 2. Beverage 11, 15 and 16 had inulin added by dry blending in step 1 and di magnesium phosphate and tri-potassium citrate monohydrate addition after step 3 and prior to step 4. The sweeteners and flavours (Erythritol, stevia, vanilla, cocoa powder and chocolate flavour) used in beverage 17 and 18 were added after step 5. Beverage 11, 12, 15 and 16 were adjusted to pH 6.8 with citric acid. It was found that the beverages that did not include a chelator (tri-potassium citrate monohydrate) did not need pH adjustment.

The compositions of the beverages are shown in Table 15.

TABLE 15

| | 11 | 12 | | | 15 | 16 | | |
|---|---|---|---|---|---|---|---|---|
| Ingredients | (comparative | (comparative | | | (comparative | (comparative | | |
| (% w/w) | with citrate) | with citrate) | 13 | 14 | with citrate) | with citrate) | 17 | 18 |
| Water | 86.73 | 83.97 | 84.27 | 84.38 | 87.07 | 86.94 | 86.09 | 86.09 |
| MPC B | | 14.84 | | | | | | |
| (control) | | (9.63 | | | | | | |
| | | casein) | | | | | | |
| MPC C | 11.19 | | | | | | | |
| | (7.39 | | | | | | | |
| | casein) | | | | | | | |
| MPC D | | | 14.54 | 14.49 | 10.82 | 10.82 | 10.76 | 10.76 |
| | | | (9.36 | (9.33 | (6.97 | (6.97 | (6.93 | (6.93 |
| | | | casein) | casein) | casein) | casein) | casein) | casein) |
| Canola oil | 0.69 | 0.79 | 0.79 | 0.69 | 0.74 | 0.74 | 0.57 | 0.47 |
| Inulin | 0.35 | | | | 0.35 | 0.35 | | |
| Di | 0.16 | | | | 0.14 | 0.14 | | |
| Magnesium | | | | | | | | |
| phosphate 3 | | | | | | | | |
| hydrate | | | | | | | | |
| Lecithin | 0.10 | 0.20 | 0.20 | 0.10 | 0.10 | 0.10 | | |
| Tri- | 0.27 | 0.43 | | | 0.27 | 0.40 | | |
| potassium | | | | | | | | |
| citrate | | | | | | | | |
| monohydrate | | | | | | | | |
| Citric acid | 0.50 | 0.19 | | | 0.50 | 0.50 | | |
| (2.5%) | | | | | | | | |
| only added | | | | | | | | |
| where | | | | | | | | |
| needed to | | | | | | | | |
| adjust pH | | | | | | | | |
| Erythritol | | | | | | | 1.5 | 1.5 |
| Stevia | | | | | | | 0.06 | 0.06 |
| Vanilla | | | | | | | 0.2 | |
| Cocoa | | | | | | | | 1.0 |
| powder | | | | | | | | |
| Flavour— | | | | | | | | 0.12 |
| chocolate | | | | | | | | |

The nutritional information for the beverages is shown in Table 16.

TABLE 16

| Per 100 ml | 11 | 12 | 13 | 14 | 15 | 16 | 17 | 18 |
|---|---|---|---|---|---|---|---|---|
| Energy (Cal) | 50.20 | 64.70 | 63.57 | 60.02 | 50.50 | 50.50 | 43.27 | 45.77 |
| Protein (g) | 9.49 | 11.94 | 12.14 | 12.13 | 9.60 | 9.60 | 8.66 | 8.88 |
| Fat (g) | 0.83 | 1.11 | 1.16 | 0.98 | 1.02 | 1.02 | 0.72 | 0.73 |
| Carbohydrate | 1.00 | 0.89 | 0.72 | 0.66 | 0.97 | 0.97 | 1.99 | 2.52 |
| (g) | | | | | | | | |
| Total solids | 12.65 | 15.50 | 15.50 | 14.50 | 12.26 | 12.38 | 13.03 | 13.97 |
| (g) | | | | | | | | |
| Energy | 84.4 | 86.8 | 83.7 | 88.4 | 78.4 | 78.4 | 80.0 | 77.6 |
| coming from | | | | | | | | |
| protein (%) | | | | | | | | |

The results of the sediment testing are shown in Table 17. The results of viscosity testing are shown in Table 18 and FIG. 4.

TABLE 17
Sediment (g/200 ml) of beverage

| Beverage | | | | | |
|---|---|---|---|---|---|
| number | 1 Month | 3 Month | 6 Month | 9 Month | 12 Month |
| Beverage 11 | 6.4 | 11.1 | 6.5 | 5.0 | 9.8 |
| (comparative | | | | | |
| with citrate) | | | | | |
| Beverage 12 | 0.9 | 1.5 | 20.1 | ND | ND |
| (comparative | | | | | |
| with citrate) | | | | | |
| Beverage 13 | 0.7 | 0.6 | 1.2 | 2.8 | — |
| Beverage 14 | 0.5 | 0.9 (4 | 1.1 | — | — |
| | | Month) | | | |
| Beverage 15 | 0.2 | 0.3 | 0.6 | — | 1.2 |
| (comparative | | | | | |
| with citrate) | | | | | |
| Beverage 16 | 0.3 | 0.2 | 3.2 | — | 0.6 |
| (comparative | | | | | |
| with citrate) | | | | | |
| Beverage 17 | 0.6 | 1.5 | 0.06 | | |
| Beverage 18 | 1.4 | 1.6 | 1.3 | | |

Beverage 12 (comparative with citrate and a standard MPC without calcium depletion) showed very poor performance, but the reason for this was unclear. It may be the higher protein/casein content beverage (9.63% w/w casein) is less stable. Higher casein levels are generally considered to be more difficult to stabilize.

Beverages 13 and 14 had 9.36 and 9.33% w/w casein. Despite having higher casein levels than beverages 17 and 18, beverages 13 and 14 still showed good/acceptable stability.

Comparative beverages 15 and 16 contained a calcium chelator stabilizer (tri-potassium citrate monohydrate) and had the expected stability brought by their use. However, beverages 17 and 18 did not include a calcium chelator, but still surprisingly had good/acceptable stability. Beverages 17 and 18 had improved stability when compared to beverage 2 in Example 1 (no citrate and standard MPC) and were also comparable to beverage 3 in Example 1 (standard MPC with citrate stabilizer).

TABLE 18
Viscosity (cP) of beverage (measured at a temperature
of 20° C. and shear rate of 100 s⁻¹)

| Beverage | 1 | 3 | 6 | 9 | 12 |
|---|---|---|---|---|---|
| number | Month | Month | Month | Month | Month |
| Beverage 11 | 10.4 | 10.3 | 13.2 | 15.1 | 14 |
| (comparative) | | | | | |
| Beverage 12 | 41.7 | 78.5 | 160 | ND | ND |
| (comparative) | | | | | |
| Beverage 13 | 13.6 | 12 | 13.4 | 14.4 | — |
| Beverage 14 | 9.49 | 6.85 (4 | 17.5 | — | — |
| | | month) | | | |
| Beverage 15 | 7.13 | 6.79 | 7.62 | — | 8.56 |
| (comparative) | | | | | |
| Beverage 16 | 7.72 | 7.81 | 9.19 | — | 9.18 |
| (comparative) | | | | | |
| Beverage 17 | 4.84 | 4.25 | 2.68 | | |
| Beverage 18 | 5.86 | 4.99 | 5.99 | | |

### Example 5—Beverage with Thickener

A beverage was prepared using a relatively high concentration of milk protein concentrate (MPC) with a thickener to test and compare the stability and/or amount of sediment formed during storage. No calcium chelator was used. The viscosity of the beverage over time was also measured.

The beverage was prepared according to the general procedure in Example 2. The gellan gum was added in step 1 with the protein powder. Flavours and sweeteners were added as described in Example 4. No pH adjustment was used or was necessary.

The composition of the beverage is shown in Table 19.

TABLE 19

| Ingredients (% w/w) | Beverage 19 |
|---|---|
| Water | 84.07 |
| MPC D | 14.07 (9.06 casein) |
| Canola oil | 0.32 |
| Lecithin | 0.1 |
| Cocoa powder | 1.00 |
| Flavor - chocolate | 0.25 |
| Gellan Gum (thickener) | 0.14 |
| Sucralose | 0.02 |
| Acesulfame K | 0.015 |

The nutritional information for the beverages is shown in Table 20.

TABLE 20

| Per 100 ml | Beverage 19 |
|---|---|
| Energy (Cal) | 56.92 |
| Protein (g) | 11.56 |
| Fat (g) | 0.73 |
| Carbohydrate (g) | 1.31 |
| Total solids (g) | 15.9 |
| Energy coming from protein (%) | 81.2 |

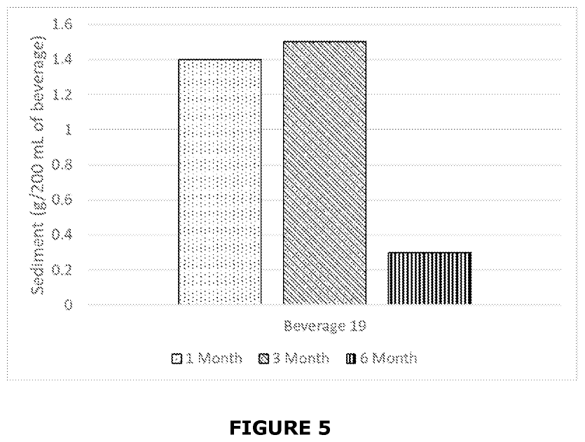

The results of the sediment testing are shown in Table 21. The results of viscosity testing are shown in Table 22 and FIG. 5.

TABLE 21
Sediment (g/200 ml) of beverage

| Beverage number | 1 Month | 3 Month | 6 Month |
|---|---|---|---|
| Beverage 19 | 1.4 | 1.5 | 0.3 |

TABLE 22
Viscosity (cP) of beverage (measured at a temperature
of 20° C. and shear rate of 100 s⁻¹)

| Beverage number | 1 Month | 3 Month | 6 Month |
|---|---|---|---|
| Beverage 19 | 31.2 | 28.2 | 34.6 |

Beverage 19 had a comparatively high casein level so would be expected to have poor stability. However, it showed good stability over 6 months. For comparison, beverage 12 had a similar casein level, but used a standard MPC (no calcium depletion) and even though it included a citrate stabilizer, it performed badly over 6 months.

The viscosity of beverage changed by less than or went up by less than 5 cP between month 1 and month 3 or month 6.

1. A beverage comprising:
about 4-15% w/w casein with a calcium to casein ratio of about 1.8-3.2 g calcium to 100 g casein,
about 0-15% w/w fat,
about 0-30% w/w carbohydrate,
wherein the casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk,
wherein the beverage does not substantially contain or does not contain a stabilizing amount of stabilizers:
(i) polysaccharide thickener, and
(ii) calcium chelator,
wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate).

2. A beverage comprising:
about 7.5-15% w/w casein with a calcium to casein ratio of about 1.8-3.2 g calcium to 100 g casein,
about 0-15% w/w fat,
about 0-30% w/w carbohydrate,
about 0-5% w/w polysaccharide thickener,
wherein the casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk,
wherein the beverage does not substantially contain or does not contain a stabilizing amount of a calcium chelator,
wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate).

3. The beverage as claimed in claim 1 or 2 wherein the beverage is a sterilized beverage.

4. The beverage as claimed in any one of claims 1 to 3 wherein the calcium to casein ratio is about 1.8-3.1 g of calcium per 100 g of casein, preferably about 1.9-3.1 g of calcium per 100 g of casein, preferably about 1.9-3.0 g of calcium per 100 g of casein preferably about 1.9-2.9 g of calcium per 100 g of casein preferably about 1.9-2.8 g of calcium per 100 g of casein preferably about 2.0-2.7 g of calcium per 100 g of casein, preferably about 2.0-2.6 g of calcium per 100 g of casein.

5. The beverage as claimed in any one of claims 1 to 4 wherein the casein is provided by a combination of a non-calcium depleted dairy ingredient with a calcium depleted dairy ingredient.

6. The beverage as claimed in any one of claims 1 to 5 wherein the casein is provided by any one of:
i) milk protein concentrate with about 5-45% w/w calcium depletion, or
ii) micellar casein (MC) with about 5-45% w/w calcium depletion, or
iii) calcium depleted milk protein concentrate (MPC) with about 10-95% w/w calcium depletion and/or calcium depleted micellar casein with about 10-95% w/w calcium depletion combined with milk protein concentrate (MPC) and/or micellar casein (MC), or
iv) skim milk powder (SMP) and/or whole milk powder (WMP) combined with calcium depleted MPC and/or calcium depleted micellar casein.

7. The beverage as claimed in any one of claims 1 to 6 wherein the casein is at least in part provided by a calcium depleted dairy ingredient wherein the dairy ingredient has greater than about 1-100% w/w calcium depletion, preferably about 10-100% w/w calcium depletion, preferably about 10-95% w/w calcium depletion, preferably about 5-45% w/w calcium depletion, preferably about 10-40% w/w calcium depletion.

8. The beverage as claimed in any one of claims 1 to 7 wherein the casein is provided at least in part by calcium depleted milk protein concentrate (MPC) or a mixture of calcium depleted milk protein concentrate (MPC) and non-calcium depleted milk protein concentrate (MPC).

9. The beverage as claimed in any one of claims 1 to 8 wherein the casein is only provided by calcium depleted milk protein concentrate (MPC) or a mixture of calcium depleted milk protein concentrate (MPC) and non-calcium depleted milk protein concentrate (MPC).

10. The beverage as claimed in any one of claims 1 to 9 wherein the casein is only provided by calcium depleted milk protein concentrate (MPC) or a mixture of calcium depleted milk protein concentrate (MPC) and non-calcium depleted milk protein concentrate (MPC), wherein the mixture has an overall calcium depletion of 5-45% w/w.

11. The beverage as claimed in any one of claims 1 to 10 wherein where whey is present, the whey protein has been heated to denature at least a portion of the whey protein.

12. The beverage as claimed in any one of claims 1 to 11 wherein the beverage has a shelf life of at least 3 months, preferably at least 4 months, preferably at least 5 months, preferably at least 6 months, preferably at least 1 year.

13. The beverage as claimed in any one of claims 1 to 12 wherein the beverage produces less than about 2 g/200 mL of sediment when stored at about 25° C. for 3 months, preferably the beverage produces less than about 1.5 g/200 mL of sediment when stored at about 25° C. for 3 months, preferably the beverage produces less than about 1 g/200 mL of sediment when stored at about 25° C. for 3 months.

14. The beverage as claimed in any one of claims 1 to 13 wherein the beverage produces less than about 2 g/200 mL of sediment when stored at about 25° C. for 6 months, preferably less than about 1.5 g/200 mL of sediment when stored at about 25° C. for 6 months, preferably less than about 1 g/200 mL of sediment when stored at about 25° C. for 6 months, preferably less than about 0.5 g/200 mL of sediment when stored at about 25° C. for 6 months.

15. The beverage as claimed in any one of claims 1 to 14 wherein the beverage comprises about 4.5-19% w/w milk protein, preferably the beverage comprises about 5-19% w/w milk protein, preferably the beverage comprises about 5-17% w/w milk protein, preferably the beverage comprises about 5-15% w/w milk protein, preferably the beverage comprises about 7-15% w/w milk protein, preferably the beverage comprises about 8-15% w/w milk protein, preferably the beverage comprises about 10-15% w/w milk protein.

16. The beverage as claimed in any one of claims 1 to 15 wherein the beverage further comprises any one or more of: whey protein, vegetable protein, collagen.

17. The beverage as claimed in any one of claims 1 to 16 wherein the beverage comprises about 0-2% w/w whey protein, preferably the beverage comprises about 0.01-2% w/w whey protein, preferably the beverage comprises about 0.05-2% w/w whey protein, preferably the beverage comprises about 0.1-2% w/w whey protein, preferably the beverage comprises about 0.5-2% w/w whey protein, preferably the beverage comprises about 1-2% w/w whey protein.

18. The beverage as claimed in any one of claims 1 to 17 wherein the beverage comprises about 0-20% w/w carbohydrate, preferably the beverage comprises about 0-10% w/w carbohydrate, preferably the beverage comprises about 0-5% w/w carbohydrate, preferably the beverage comprises about 0-2% w/w carbohydrate, preferably the beverage comprises about 10-30% w/w carbohydrate.

19. The beverage as claimed in any one of claims 1 to 18 wherein the beverage comprises about 0-14% w/w fat, preferably about 0-13% w/w fat, preferably about 0-10% w/w fat, preferably about 0-5% w/w fat, preferably about 0-2% w/w fat, preferably about 0-1.5% w/w fat, or about 5-15% w/w fat, preferably about 5-12% w/w fat, preferably about 5-10% w/w fat, preferably about 5-8% w/w fat.

20. The beverage as claimed in any one of claims 1 to 19 wherein the beverage has total solids of about 4 to 60% w/w, preferably about 5 to 50% w/w, preferably about 5 to 40% w/w, preferably about 5 to 30% w/w, preferably about 10 to 30% w/w.

21. The beverage as claimed in any one of claims 1 to 20 wherein the beverage comprises one or more additional mineral(s) and/or vitamin(s).

22. The beverage as claimed in any one of claims 1 to 21 wherein about 7-100% of the energy provided by the beverage is provided by protein, preferably about 10-30% of the energy provides by the beverage is provided by protein, preferably about 60-100% of the energy provides by the beverage is provided by protein.

23. The beverage as claimed in any one of claims 1 to 22 wherein the beverage comprises about 0-5% w/w lactose and/or products of lactose hydrolysis, preferably the beverage comprises about 0-4% w/w lactose and/or products of lactose hydrolysis, preferably the beverage comprises about 0-3% w/w lactose and/or products of lactose hydrolysis, preferably the beverage comprises about 0-2% w/w lactose and/or products of lactose hydrolysis, preferably about 0-1% w/w lactose and/or products of lactose hydrolysis.

24. The beverage as claimed in any one of claims 1 to 23 wherein the pH of the beverage is about 6.5-7.4, preferably about 6.6-7.2, preferably about 6.6-7.0, preferably about 6.7-6.9.

25. The beverage as claimed in any one of claims 1 to 24 wherein beverage has received a sterilizing heat treatment.

26. The beverage as claimed in claim 25 wherein the sterilizing heat treatment is UHT or retort.

27. The beverage as claimed in claim 25 or 26 wherein the sterilizing heat treatment is high temperature sterilizing, preferably the high temperature is about 90° C. to about 150° C. for about 0.25 second to about 60 minutes, preferably the high temperature sterilization comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, 60 seconds or at least about 1, 2, 3, 4, 5, 6, 7, 8, 9, 10 or at least about 60 minutes, preferably the high temperature sterilizing comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 s to about 10 minutes, about 0.1 s to about 1 minute, about 0.1 s to about 30 s, about 0.5 s to about 30 s, about 1 s to about 30 s, about 3 s to about 30 s about 0.1 s to about 20 s, about 0.5 to about 20 s, about 1 to about 20 s, about 3 to about 20 s, about 0.1 to about 10 s, about 1 to about 10 s, about 3 to about 10 s, about 0.1 to about 7 s, about 1 to about 7 s, about 3 to about 7 s, about 0.1 to about 5 s, about 1 to about 5 s or about 3 s to about 5 s, preferably the high temperature sterilizing comprises heat treating the beverage at a temperature of at least about 115° C. for at least about 2 s, at least about 120° C. for at least about 2 s, at least about 125° C. for at least about 2 s, at least about 130° C. for at least about 1 s, at least about 135° C. for at least about 1 s, at least about 138° C. for at least about 1 s, at least about 130° C. for at least about 3 s, at least about 135° C. for at least about 3 s, at least about 138° C. for at least about 3 s, from about 130 to about 150° C. for at least about 1 s, from about 130 to about 150° C. for at least about 3 s, from about 135 to about 150° C. for at least about 1 s, from about 135 to about 150° C. for at least about 3 s, from about 138 to about 145° C. for at least about 1 s, from about 138 to about 145° C. for at least about 3 s, at least about 130° C. for about 1 s to about 10 s, at least about 135° 5 C for about 1 s to about 10 s, at least about 138° C. for about 1 s to about 10 s, from about 135 to about 150° C. for about 1 s to about 10 s, from about 138 to about 145° C. for about 1 s to about 10 s, from about 135 to about 150° C. for about 3 s to about 5 s, or from about 138 to about 145° C. for about 3 s to about 5 s.

28. The beverage as claimed in any one of claims 25 to 27 wherein sterilization gives an Fo value of at least about 5, or at least about 3, preferably the heat treatment has an Fo value of at least equivalent to 90° C. for 40 s, 121.1° C. for 3 min, 130° C. for 25 s, 140° C. for 2.5 s or 150° C. for 0.25 s.

29. A process of making a beverage, the process comprising:
heating at a sterilization temperature an aqueous mixture comprising
about 4-15% w/w casein with a calcium to casein ratio of about 1.8-3.2 g calcium to 100 g casein,
about 0-15% w/w fat,
about 0-30% w/w carbohydrate,
wherein the casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk,
wherein the beverage does not substantially contain or does not contain a stabilizing amount of stabilizers:
(i) polysaccharide thickener, and
(ii) calcium chelator,
wherein the polysaccharide thickener consists of the group: a starch, gellan, carrageenan, xanthan, carboxymethyl cellulose (CMC), microcrystalline cellulose (MCC), guar, pectin, alginate, agar, locust bean gum, gum Arabic, tragacanth, karaya gum;
wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate).

30. A process of making a beverage, the process comprising:
heating at a sterilization temperature an aqueous mixture comprising
about 4-15% w/w casein with a calcium to casein ratio of about 1.8-3.2 g calcium to 100 g casein,
about 0-15% w/w fat,
about 0-30% w/w carbohydrate,
about 0-5% w/w polysaccharide thickener,
wherein the casein is provided by any one or more of the following dairy ingredients: calcium depleted milk protein concentrate (MPC), non-calcium depleted milk protein concentrate (MPC), calcium depleted milk protein isolate (MPI), non-calcium depleted milk protein isolate (MPI), calcium depleted liquid milk protein concentrate, non-calcium depleted liquid milk protein concentrate, calcium depleted liquid micellar casein, non-calcium depleted liquid micellar casein, calcium depleted ultrafiltration (UF) and/or microfiltration (MF) retentate of milk, non-calcium depleted ultrafiltration (UF) and/or microfiltration (MF) retentate of milk, calcium depleted micellar casein, non-calcium depleted micellar casein, calcium depleted skim milk powder (SMP), skim milk powder (SMP), calcium depleted whole milk powder (WMP), whole milk powder (WMP), calcium depleted skim milk, skim milk, calcium depleted whole milk, whole milk,
wherein the beverage does not substantially contain or does not contain a stabilizing amount of a calcium chelator,
wherein the calcium chelator consists of E331 (sodium citrates, (i) Monosodium citrate (ii) Disodium citrate (iii) Sodium citrate (trisodium citrate)), E332 (Potassium citrates (i) Monopotassium citrate (ii) Potassium citrate (tripotassium citrate)), E335 (sodium L-tartrate, Sodium tartrates (i) Monosodium tartrate (ii), Disodium tartrate), E336 (Potassium L tartrate, Potassium tartrates (i) Monopotassium tartrate (cream of tartar) (ii) Dipotassium tartrate), E337 (sodium potassium tartrate), E339 (Sodium phosphates (i) Monosodium phosphate (ii) Disodium phosphate (iii) Trisodium phosphate), E340 (Potassium phosphates (i) Monopotassium phosphate (ii) Dipotassium phosphate (iii) Tripotassium phosphate), E365 (Monosodium fumarate), E450 (Diphosphates (i) Disodium diphosphate (ii) Trisodium diphosphate (iii) Tetrasodium diphosphate (iv) Dipotassium diphosphate (v) Tetrapotassium diphosphate), E451 (Triphosphates (i) Sodium triphosphate (pentasodium triphosphate) (ii) Pentapotassium triphosphate), E452 (Polyphosphates (i) Sodium polyphosphates (ii) Potassium polyphosphates (v) Ammonium polyphosphate, E452(i) sodium hexametaphosphate).

31. The process of making a beverage as claimed in claim 30 wherein the calcium to casein ratio is about 1.8-3.1 g of calcium per 100 g of casein, preferably about 1.9-3.1 g of calcium per 100 g of casein, preferably about 1.9-3.0 g of calcium per 100 g of casein preferably about 1.9-2.9 g of calcium per 100 g of casein preferably about 1.9 -2.8 g of calcium per 100 g of casein preferably about 2.0-2.7 g of calcium per 100 g of casein, preferably about 2.0-2.6 g of calcium per 100 g of casein.

32. The process of making a beverage as claimed in any one of claims 29 to 31 wherein the casein is provided by a combination of a non-calcium depleted dairy ingredient with a calcium depleted dairy ingredient.

33. The process of making a beverage as claimed in any one of claims 29 to 32 wherein the heating at a sterilizing temperature is UHT or retort treatment.

34. The process of making a beverage as claimed in any one of claims 29 to 33 wherein the sterilization temperature is high temperature.

35. The process of making a beverage as claimed in any one of claims 29 to 34 wherein the aqueous mixture is warmed to facilitate mixing.

36. The process of making a beverage as claimed in any one of claims 29 to 35 wherein the beverage is homogenised, preferably the beverage is homogenised at a total homogenising pressure of about 100 to about 1000 bars, preferably a total homogenising pressure of about 100 to about 600 bars, preferably a total homogenising pressure of about 100 to about 500 bars, preferably a total homogenising pressure of about 100 to about 400 bars.

37. The process of making a beverage as claimed in any one of claims 29 to 36 wherein the sterilized beverage is cooled under aseptic conditions.

38. The process of making a beverage as claimed in any one of claims 29 to 36 wherein the sterilized beverage is aseptically packaged.
